(19) United States
(12) Patent Application Publication
(10) Pub. No.: US 2025/0043076 A1
(43) Pub. Date: Feb. 6, 2025

(54) POLYPROPYLENE IMINE POLYMERS (PPI), THEIR PREPARATION, USES, AND COMPOSITIONS COMPRISING SUCH PPI

(71) Applicant: BASF SE, Ludwigshafen am Rhein (DE)

(72) Inventors: Holger TUERK, Ludwigshafen (DE); Eugen RISTO, Ludwigshafen (DE); Guido VANDERMEULEN, Ludwigshafen (DE)

(21) Appl. No.: 18/711,751

(22) PCT Filed: Dec. 9, 2022
(86) PCT No.: PCT/EP22/85186

§ 371 Date: May 20, 2024

(30) Foreign Application Priority Data
Dec. 20, 2021 (EP) 21215963.6

(51) Int. Cl. C08G 73/02; C11D 3/37

(52) U.S. Cl. CPC C08G 73/0213; C11D 3/3723; C11D 3/3788; C11D 2111/12; C11D 2111/14

(57) ABSTRACT

Disclosed herein are polypropylene imine polymers (PPI) and their derivatives having side chains originating from polycondensation or polyaddition reactions using alkylene oxides, and lactones and/or hydroxy carbon acids, a process of producing same, and methods of using the same, for example in laundry or dishwashing.

This invention deals with polypropylene imine homo- and copolymers (in this present invention abbreviated as “PPI” or “inventive polymer” or “polymer of the invention” whenever the inventive polymers are meant), their manufacture, their uses, particularly for use in cleaning compositions such as laundry and dish washing detergent compositions, and specifically for improved oily/fatty soil removal in laundry care and improved degreasing properties in dishwashing, to prevent or reduce glass corrosion in dish washing, and many more.

Furthermore, in the following, any alkylene oxide is generically referred to as “AO”, ethylene oxide is sometimes referred to as “EO”, propylene oxide as “PO”; butylene oxide as “BuO”. “PEO” is used sometimes herein to describe polyethylene oxide homopolymers or PEO-blocks within a larger polymer structure; likewise, “PPO” describes the poly propylene oxide homopolymers or polymer-blocks within a larger polymer structure.

Detergent formulators are continuously faced with the task of developing improved products to remove a broad spectrum of soils and stains from fabrics and hard surfaces. Chemically and physico-chemically, the varieties of soils and stains range the spectrum from polar soils, such as proteinaceous, clay, and inorganic soils, to non-polar soils, such as soot, carbon-black, by-products of incomplete hydrocarbon combustion, and organic soils like sebum. The removal of greasy (i.e., oily/fatty) stains has been a particularly challenging problem. This challenge has been accentuated by the recent high interest and motivation to reduce the level of surfactants in cleaning detergents for environmental, sustainability and cost reasons. The reduction of level of surfactants, especially oil-derived surfactants, such as linear alkyl benzene sulfonate, LAS, has typically been found to lead to an erosion of oily/fatty stain removal. Additionally, the global trend of using washing conditions at lower temperature further diminishes grease cleaning capabilities of typical detergents, since the class of oily and fatty stains shows the greatest performance drop when the temperature is decreased. Also, the task to reduce or avoid and prevent glass corrosion during the cleaning of glassy surfaces of any kind, especially in dish washing and even more in automatic dish washing (the latter referred to sometimes also as “ADW”), poses another challenge.

Another global trend is the compaction of laundry and dish wash detergents, in order to improve the sustainability in terms of water usage and/or transportation costs, as well as to improve the convenience for the end consumer (e.g., single mono dose products, tabs, pouches and the like), which leads to a high market demand for new raw materials that have a higher weight-efficiency and a significantly broader performance profile.

A further strongly emerging trend is the desire to improve the “footprint” of any product, be it in terms of its origin like being from natural or renewable resources, or all compared to previous products—its production in terms of production efficiency and thus reduced usage of energy, its efficiency in usage such as reduced amounts for the same performance or higher performance at the same amount levels used, its persistence in the natural environment upon and/or after its usage such as bio-degradation.

Hence, due to the climate change, one of the most important targets of for example the detergent and cleaner (D&C) industry today is to significantly lower the CO2 emission per wash, by improving cold water conditions, improving the cleaning efficiency at low temperatures of below 40, 30 or 20 or even colder, and to lower the amounts of chemicals employed per wash, and increasing the weight-efficiency of the cleaning technologies. Another technical hurdle is the reduction of glass corrosion in automatic dish washing (ADW) to generally extend the lifetime of dishware and thereby to contribute to an overall improved sustainability. Another important target of the D&C industry is the need for biodegradable polymers, to improve the sustainability of the detergent formulations and to avoid the accumulation of non-degradable polymers or polymer blocks resulting from incomplete biodegradation of polymers (persistent blocks) in the ecosystem, thus lowering the persistence in nature after usage of the materials.

As a result of these trends, there is a strong need for new biodegradable cleaning polymers that provide both excellent primary (i.e., soil removal) and secondary (i.e., whiteness maintenance) cleaning benefits for both hydrophobic and hydrophilic stains, and that do not contain any persistent block within their macromolecular architecture. The materials should exhibit good soil removal for oily/fatty and particulate stains and should also lead to improved whiteness maintenance, minimizing the amount of suspended and emulsified oily/fatty and particulate soil from redepositing on the surfaces of the textiles or hard surfaces. Preferably, the new ingredients would also display a synergy with other cleaning polymers known for improving solely the oily/fatty or particulate stain removal and/or whiteness of fabrics and hard surfaces, leading to further improved detergent compositions.

As a result of these trends the need is evolving for new biodegradable polymers that reduce the glass corrosion in ADW, to extend the lifetime of dishware, especially of glasses, and that do not contain any persistent block within their macromolecular architecture.

Alkoxylated polyalkylene imine polymers, especially the class of alkoxylated branched PEI and alkoxylated linear polypropylene imine homo- and copolymers, are known in the literature to be able to contribute to particulate or to oily/fatty soil removal, especially at low lower surfactant levels and at cold water conditions (30° C. and lower). However, their performance is not sufficient, both from a perspective of oily/fatty soil removal capability and also from a perspective of a broader performance profile. In addition, the known polypropylene imine homo- and copolymers of the present art are difficult to synthesize and to further process in an industrial scale. Moreover, their biodegradation performance generally is low or even poor, especially in terms of being free of any persistent block, and thus not acceptable for current new and future requirements. Hence, there was a need to find improved polymer architectures with a superior performance profile, a feasible preparation process and a fully biodegradable (i.e., all starting materials, potentially hydrolyzed building blocks in aqueous environment and the final molecule) scaffold.

In the following, a summary of the most relevant publications in the field of the present invention is given.

Alkoxylated polyalkylene imines are well known as additives for laundry detergents (e.g., EP3301154, EP3167034, EP112593 and WO2020/030469) or hard surface cleaners.

EP2209837B1 describes amphiphilic water-soluble alkoxylated polyalkylene imines, for improved oily/fatty stain removal in detergents. In general, various polyalkylene imines may be used as core materials which are based on different radicals A1 interconnecting the nitrogen atoms. The radicals A1 might be identical or different, linear or branched C2-C6-alkylene radicals, such as 1,2-alkylenes. Preferably, 1,2-ethylene, 1,2-propylene and 1,6-hexamethylene are being used. Usage of 1,3-propylene is not mentioned at all. In focus of this patent are linear oligoamines such as 1,6-hexamethylene diamine as well as branched polyethylene imines, as disclosed in the examples. Linear polypropylene imines are not mentioned. The polymers contain PEO/PPO block modification with 24 to 50 EO units and 30 to 50 PO units, thus the alkoxylate chains are longer than those described in WO2006108856A2. Due to the longer PEO/PPO chains, their performance in terms of oily/fatty soil removal is improved. Biodegradability of the polyamines themselves and of the alkoxylated derivatives are not mentioned at all.

More specifically, polypropylene imines and alkoxylated polypropylene imines for cleaning applications are described in EP 2 961 819 B1, which discloses such polymers with number average molecular weight Mn of the backbone being in the range of from 300 to 4,000 g/mol, preferably from 400 to 2,000 g/mol, determined by size exclusion chromatography. In a preferred embodiment it is defined that the molar mass distribution Mw/Mn of backbone of alkoxylate is in the range from 1.2 to 20, preferably from 1.5 to 7.5. However, those alkoxylated polymers are not biodegradable.

Even more specifically, polyethylene/-propylene imine copolymers are described in the still unpublished patent application PCT/EP2021/065279, which discloses as claim 7: “Polyethylene/-propylene imine copolymers before alkoxylation, comprising in condensed form repeating units of monomer (A) and monomer (B) and monomer (C), as defined above in any one of claims 1 to 7.” Monomer A in this unpublished patent application resembles monomer A in this present invention when the variables n and l each are 1 (see Embodiment 1 below); monomer B (only for the variable m=1) in this unpublished patent application resembles monomer B of the present invention. Monomer C in this unpublished patent application is different from monomer C of the present invention: Monomer C of this unpublished patent application is not used in this present invention since monomer C in this unpublished patent application leads to very poor biodegradability of the polyamine due to its tertiary amino group in the backbone. However, the copolymers disclosed in claim 7 of this unpublished patent application contain monomer C. This patent application further discloses “Alkoxylated polyethylene/-propylene imine copolymers according to any one of claims 1 to 4 (which include a backbone made only from monomer A and B, and not containing monomer C), wherein the weight-average molecular weight Mw of the polyethylene/-propylene imine backbone without alkoxy chains is at least 300 g/mol, preferably at least 500 g/mol.” In contrast, described in the experimental section is only a polymer based on backbone A.2 comprising monomer A (1,3-propylene diamine, i.e. being equal to monomer A of this present invention) and monomer B of this invention (when n, I=1 in the structure of monomer B of this invention) with a weight-average molecular weight off 767 g/mol.

However, this polyamine A.2 with Mw 767 g/mol is not biodegradable. Furthermore, all alkoxylated polymers in this unpublished patent application are not biodegradable.

WO 2021/165468 and unpublished patent applications EP 21176904.7, EP 21176906.2, EP 21192170.5 and EP 21192169.7 describe modified polyalkylene imines and -amines which show better biodegradation than the previously known compounds due to modification in the side chains, which are made from alkylene oxides and lactones/hydroxy carbon acids, leading to ester and/or amide functionalities in the side chain. However, the cores of the modified polyalkylene imines still are not biodegradable. WO 2021/165468 discloses that the molecular weight (Mw) of the polyalkylene imine backbone or of the polyamine backbone lies in the range of 50 to 10 000 g/mol, preferably in the range of 500 to 5000 g/mol, more preferably in the range of 600 to 2 000 g/mol. The only polyamines mentioned in the experimental section, besides one low molecular weight oligoamine (N4-Amine with MW 174 g/mol), are branched polyethylene imines which have a different structure and a different (i.e., higher) molecular weight than those polyamines of the present invention and are therefore not biodegradable.

Unmodified polyalkylene imines are well known as additives for automatic dish wash detergents, to prevent glass corrosion of dish ware. EP2768935B1, EP2981600B1 and EP2768937B1 describe ADW compositions based on chelating agents like methylglycinediaceticacid (MGDA), glutamic acid diacetate (GLDA), citric acid and salts thereof, and linear or branched polyethylene imines. Optionally, at least one zinc salt is added to the compositions to further reduce the glass corrosion. The mentioned linear or branched polyethylene imines are not biodegradable. Polypropylene imines are not mentioned at all.

Although there have been already many different polyalkylene imines and alkoxylated polyalkylene imines described in the cited publications above, including their preparation process and their use in detergents, there is still a need for polymers that have a higher weight-efficiency, i.e. that exhibit further improved benefits such as on oily/fatty stain removal in laundry and/or improved degreasing benefits in manual dishwashing at lower implementation concentrations, in combination with a significantly broader performance profile (2-in-1 solution), and/or improved prevention of glass corrosion in ADW, and in particular new polymers having an improved biodegradation within 28 or 56 days under controlled conditions as defined by OECD 301 B and/or F, enabling among others the design of highly concentrated and sustainable (i.e., fully degradable and non-persistent) multi-benefit detergent formulations.

More specifically, there is still a strong need for new cleaning polymers that provide both excellent primary (i.e., soil removal) and secondary (i.e., whiteness maintenance) cleaning benefits, ideally for both hydrophobic and hydrophilic stains. Furthermore, a simplified manufacturing process for the polyamine backbone and such backbone having polymer melting points at room temperature (25° C.+/−2) or below, is highly desired to avoid clogging of the reaction tubes and the piping, improve handling upon filling or pumping into containers or pouring or pumping from containers of either the polymers as such or in formulations, to enable a safe and feasible transamination process in an industrial scale, and easy formulation development, is needed as well.

Within the context of the present invention, non-biodegradable or persistent means less than 10% biodegradability after 28 and/or 56 days, according to the OECD 301 B and/or F test conditions. Poor biodegradability means less than 20% biodegradability after 28 days, according to the OECD 301 B and/or F test conditions and/or less than 40% biodegradability after 56 days, according to the OECD 301 B and/or F test conditions.

It has been found that certain homopolymers of PPI based on monomer A, B and/or C, preferably A and/or B, and certain copolymers of PPI (e.g., from monomers A and B) with Mn 200-400 and Mw below 700 g/mol are biodegradable, i.e., at least 20% biodegradability after 28 days, according to the OECD 301 B and/or F test conditions and/or at least 40% biodegradability after 56 days, according to the OECD 301 B and/or F test conditions. It has also been found that modifications using the structural elements, reactions and reaction procedures to modify the backbone with side chains comprising alkylene oxides and lactones/hydroxy carbon acids and thus ester-functions and/or amide-functions as disclosed in the publications WO 2021/165468 and especially those of the unpublished patent applications EP 21176904.7, EP 21176906.2, EP 21192170.5 and EP 21192169.7 lead to “modified PPI” (as defined hereinafter in this disclosure) which combine the advantage of a biodegradable core (the PPI of this invention) and a shell (resembled by the side chains) to the advantage of a final molecule that is biodegradable due to the various ester-functions and/or amide-functions between core and shell, which enhances the biodegradation rate of the total molecule (.e. of the “modified PPI”); As a result, those modified PPI have a more favorable structure for being bio-degraded than the structures to date.

The object of the present invention is to provide novel polypropylene imine polymers (in this invention abbreviated as “PPI”) comprising in polycondensed form at least one repeating unit selected from the following monomeric units:
(A) monomer (A) is represented by the following formula

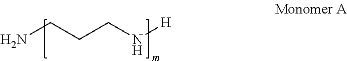

with m being selected from an integer of from 1 and up to 5,
(B) monomer (B) is represented by the following formula

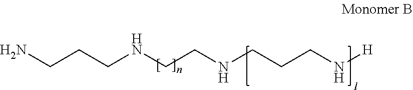

with n being selected from an integer of from 1, 3, 4 and 5, and with l being selected from 0 or 1, and
(C) monomer (C) is represented by the following formula

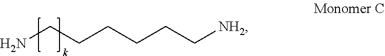

with k being selected from an integer of from 1 and up to 7.

The PPI may be further modified by reactions with alkylene oxides and lactones and/or hydroxy acids to yield PPI which bear at least one side chain attached to an NH-group of the PPI, such side chain comprising at least one AO and at least one lactone and/or hydroxy acid per side chain, and/or may be quaternized to introduce non-permanent or permanent quaternization of at least one N-group of the PPI-structure.

A PPI with such side chains is sometimes also called a “modified PPI” within this disclosure to specifically distinguish from an “unmodified” PPI bearing no such side chains, whereas the term “PPI” generally herein includes any such PPI either bearing side chains and/or being quaternized or neither bearing side chains nor being quaternized.

A process to produce such PPI is also part of this invention.

The use of such PPI of this invention for all kinds of applications for which the previously known polyamines, polyethylene imines, polypropylene imines, and their alkoxylated derivates have been used is encompassed by this present invention as well.

Compositions comprising such PPI of this invention similar to those compositions in which the previously known polyamines, polyethylene imines, polypropylene imines, and their alkoxylated derivates have been employed—either the PPI instead of such known compounds or in combinations with such known compounds—forms part of this invention as well.

The term “polymer”, “polymer of the invention” or “inventive polymer”, as used herein, refers to polypropylene imine polymer comprising at least one monomer A, monomer B and/or monomer C or combinations thereof as described below and/or in the appended claims.

Thus, subjects of the present invention are the following Embodiments 1 to 35 as defined and further explained with further embodiments hereinafter and further exemplified in the experimental section:

### Embodiment 1

Polypropylene imine polymer (PPI) comprising in polycondensed form at least one repeating unit selected from the following monomeric units:
(A) monomer (A) is represented by the following formula

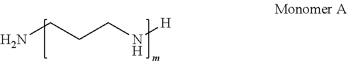

with m being selected from an integer of from 1 and up to 5,
(B) monomer (B) is represented by the following formula

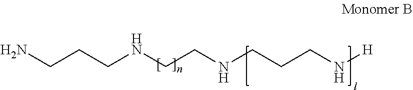

with n being selected from an integer of from 1, 3, 4 and 5, and
with l being selected from 0 or 1,
and
(C) monomer (C) is represented by the following formula

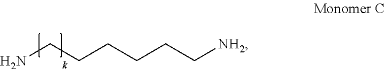

with k being selected from an integer of from 1 and up to 7, wherein preferably
i) at least one repeating unit stemming from monomer A, and/or
ii) at least one repeating unit stemming from monomer B, and/or
iii) at least one repeating unit stemming from monomer C, and/or
   and more preferably
i) at least one repeating unit stemming from monomer A, and/or
ii) at least one repeating unit stemming from monomer B, and
optionally at least one repeating unit stemming from monomer C,
   is selected.

### Embodiment 2

PPI according to Embodiment 1, containing only at least one monomer selected from i) A, ii) B, iii) A and B, iv) A and C, v) B and C, or vi) A and B and C, preferably i) A, ii) B, iii) A and B, iv) A and C, more preferably i) A and iii) A and B, and most preferably iii) A and B.

### Embodiment 3

PPI according to Embodiment 1 or 2 having a weight-average molecular weight Mw of below 700 g/mol, and preferably of at least 300 g/mol.

### Embodiment 4

PPI according to any of Embodiments 1 to 3, having a number-average molecular weight Mn from 200 to 400 g/mol and a weight-average molecular weight Mw from 300 to below 700 g/mol.

### Embodiment 5

PPI according to any of Embodiments 1 to 4, having a polydispersity index (PDI) of from 1,3 to 2.5, preferably 1.5 to 2.0.

Molecular weights of the PPI were determined by gel permeation chromatography (GPC). The measurements were carried out on a column combination of three following columns: HFIP-LG Guard, PL HFIPGEL and PL HFIPGel. Further details are disclosed in the experimental section. Molecular weights of the side-chain modified PPI (both inventive and comparative) were obtained by theoretical calculations, using the determined weight-average molecular weights of the unmodified PPI and assuming complete conversion during the modification step. Further details are disclosed in the experimental section as well.

“Mw” is the weight average molecular weight and “Mn” is number average molecular weight. The respective values of Mw and/or Mn can be determined as described within the experimental section below.

The molar mass distribution Mw/Mn is equal to the polydispersity index (PDI), the PDI being without unit [g/mol/g/mol]).

### Embodiment 6

PPI according to any of Embodiments 1 to 5, comprising on average at least 6 nitrogen atoms and at most 12 nitrogen atoms.

The number of nitrogen atoms is defined by the amounts of monomers, their ratios, and the reaction conditions. Low molecular weight PPI and thus PPI with a relatively low number of nitrogen atoms such as 6 to up to 12 have been unexpectedly found to provide useful properties such as low melting point, better biodegradation but yet at least comparable performance as detailed hereinafter.

### Embodiment 7

PPI according to any of Embodiments 1 to 6 that are essentially linear, more preferably at least to 95% linear, and more preferably completely linear.

### Embodiment 8

PPI according to Embodiment 7, containing no tertiary amino group.

In principle, polypropylene imine polymers generally may be linear or branched, with the branching forming a tertiary amino group, and branches may be (i) relatively short alkylene amino groups as such (e.g., —(CH2)3-NH2 groups) up to very long side chains which may contain further amino-groups being similarly branched etc, thus leading to highly branched structures such as the typical highly branched polyethylene imine (PEI) known to date, or (ii) hydrocarbon units not bearing further amino groups.

By consequence, the inventive PPI have a basic skeleton (backbone), which comprises primary and secondary nitrogen atoms which are joined by alkylene radicals R (with the “R” being a general representation—for the purpose of the following explanation only—of the alkyl units of the monomers A, B and C, respectively) and are in the form of the following moieties in random arrangement (such arrangement in the actual PPI according to the actual monomer structures A, B and C):
primary amino moieties which terminate the main chain and—if applicable also the side chains—of the basic skeleton and whose hydrogen atoms may be subsequently replaced by side chains when modified with alkylene oxides and lactones/hydroxy acids:

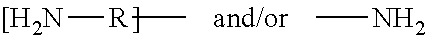

secondary amino moieties whose hydrogen atom may be subsequently replaced by side chains when modified with alkylene oxides and lactones/hydroxy acids:

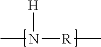

For the purposes of the present invention, definitions such as C1-C18-alkyl, for example, to depict a hydrocarbon substituent on a nitrogen atom of the PPI, mean that this substituent (radical) is in case of “C1-C18-alkyl” an alkyl radical having from 1 to 18 carbon atoms. The alkyl radical can be either linear or branched or optionally cyclic. Alkyl radicals which have both a cyclic component and a linear component likewise come within this definition. The same applies to other alkyl radicals such as a C1-C4-alkyl radical. Examples of alkyl radicals are methyl, ethyl, n-propyl, sec-propyl, n-butyl, sec-butyl, isobutyl, 2-ethylhexyl, tert-butyl (tert-Bu/t-Bu), pentyl, hexyl, heptyl, cyclohexyl, octyl, nonyl, decyl or dodecyl.

Other such typical abbreviations such as “C2-C22 alkylene oxides” and the like have their ordinary meaning as used in this field of organic chemistry.

In this invention, preferred PPI are predominantly linear, more preferably are at least to 95% linear, and more preferably are essentially linear (“essentially linear” being defined herein as comprising less than 1%, preferably less than 0.5% of tertiary nitrogen atoms), such as completely linear (“completely linear” being defined herein as containing no detectable amounts of tertiary amines). When tertiary nitrogen atoms are present, those nitrogen atoms are preferably substituted with hydrocarbon units only, more preferably with C1-C4-alkyl-groups, most preferably with C1- and/or C2-alkyl, most preferably C1-alkyl only. Most preferably, such tertiary nitrogen atoms are essentially not present and thus the PPI are essentially linear.

The degree of branching may be determined, for example, by NMR-spectroscopy such as 1H-NMR or preferably 13C-NMR.

The amine number for primary and secondary, and tertiary amines is determined in accordance with the standard DIN EN ISO 9702.

### Embodiment 9

PPI according to any one of Embodiments 1 to 8, wherein—if such monomer A, B and/or C or such group bearing such variable is present—
a) for monomer A: m is 1, 2 or 3, preferably 1, and/or
b) for monomer B: n is 1, and/or
c) for monomer B: l is 1, and/or
d) for monomer C: k is 1, and/or
   preferably all options a) to d) before being required features.

### Embodiment 10

PPI according to any of Embodiments 1 to 9, being biodegradable according to OECD 301 F within 56 days, preferably within 28 days, of at least 20 weight %, preferably of at least 25%, more preferably of at least 30, even more preferably of at least 35, and most preferably of at least 40%, and any value above.

For the purposes of this invention, biodegradation in wastewater is given as weight percent based on solid content, preferably measured in triplicate using the OECD 301 F manometric respirometry method. OECD 301 F is an aerobic test that measures biodegradation of a sample by measuring the consumption of oxygen. The consumption of oxygen is determined by measuring the change in pressure in the apparatus using an OxiTop® C (Xylem 35 Analytics Germany Sales GmbH & Co KG). The amount of oxygen taken up by the microbial population during biodegradation of the test substance is expressed as a percentage of ThOD (Theoritical oxygen demand, which is measured by the elemental analysis of the compound). Details for the tests performed are given in the experimental section below.

A main advantage of the present invention in terms of biodegradation is that not only the “shell” (i.e., the side chains in the modified PPI which are attached to the (unmodified) PPI) but also the “core” (i.e., the unmodified PPI) exhibits a useful degree of biodegradation. Currently known polyalkylene imines and their alkoxylated derivatives (including those comprising besides AO also lactones and the like) are not per se biodegradable as the core (i.e., the polyalkylene imines)) are not biodegradable to any significant extent. On the other hand, low molecular weight cores like the inventive PPI and their modified derivatives being biodegradable and additionally showing a significant and thus commercially useful performance are not known to date.

Hence, as the present invention provides PPI which itself show significant rate of biodegradation, and the modification of those PPI (as a core) with side chains which in turn also show a significant rate of biodegradation, the combined core-shell-product (i.e., the modified PPI) inherits this significant rate of biodegradation and that will, after hydrolysis in aqueous environment, exhibit only such fragments that should not be persistent in nature.

### Embodiment 11

PPI according to any one of Embodiments 1 to 10, having a melting point of at most 25° C., preferably of below 20° C., even more preferably below 15° C.

Due to the low molecular weight and thus the low number of nitrogen atoms, and further to the structures of the monomers employed, the resulting PPI exhibit a low melting point of around room temperature (defined herein as 25° C.) or—preferably—below such as below 20° C., below 15° C., below 10° C., below 5° C. or even further below. Such low melting points impart enable a more simplified production process as the resulting PPI can be handled at relatively moderate elevated temperatures or even already at room temperatures as liquids, thus easily avoiding clogging of reaction tubes, vessels and piping, improving the handling upon filling or pumping into containers or vessels or pouring or pumping from containers or vessels of either the PPI as such or in formulations. Thus, such low melting points enable a safe and feasible production process in an industrial scale, any processes needed to transport and store the PPI, easy formulation development, and generally easy handling.

### Embodiment 12

PPI according to any one of Embodiments 1 to 11, wherein the PPI is further modified by additionally comprising at least one side chain attached to at least one NH-functionality of the PPI, such chain consisting of moieties stemming from the polycondensation or polyaddition of at least one of the following further monomers
(D) at least one lactone and/or at least one hydroxy carbon acid
(E) at least one alkylene oxide (AO) being selected from C2 to C22-alkylene oxides, preferably C2 to C6, more preferably C2, C3 and/or C4,
   wherein the order of D and E within the side chains can be any order such as random, block or statistical distribution, with block order being preferred, and
   wherein the amount of D is from 0.5 to 15 based on mol equivalents per NH-functionality, and
   wherein the amount of E is within 10 to 100 based on mol equivalents per NH-functionality.

### Embodiment 13

PPI according to Embodiment 12, wherein the sum of the total amount of monomer (A), monomer (B) and monomer (C) in the PPI is at least 1 wt. % and at most 10 wt %, the rest ad 100 wt. % being the side chains.

The PPI may comprise side chains which are attached to nitrogen atoms of the PPI. The side chains may be—and preferably are—attached by way of a polycondensation or polyaddition reaction. The side chains are made up from C2-C22-alkylene oxides, lactones and/or hydroxy carbon acids. Typically, a side chain comprises at least one alkylene oxide (AO) and at least one lactone (LA) and/or at least one hydroxy acid (HA). The (poly)condensation or (poly)addition reaction to prepare a side chain comprising AO, LA and HA is—by way of example for the preparation of the side chains in general—typically done by reacting the PPI with the at least one AO and the at least one LA and/or HA either i) in a mixture of adding all ingredients employed at the very same time or at least shortly after each other with a preferably as short as possible time-lag, ii) by adding first either the AO or the LA or the HA and then the second ingredient and then the third to obtain blocks of AO, LA and HA, iii) by adding one or two ingredients as defined for method i) before and the remaining two or one ingredient(s) according to method ii) as defined before. It is of course also possible to repeat reactions with further amounts of the same ingredient type AO, LA and/or HA at a later point in time, thereby creating block structures.

Preferably, a side chain comprises more than one, more preferably more than two, even more preferably more than 3 units per NH-functionality of the PPI stemming from AO, and at least 0.5 units per NH-functionality. All such numbers are numbers “on average” meaning that such numbers refer to the average number for such unit per NH-functionality calculated based on all NH-functionalities of a PPI.

Additionally, it has to be noted within the context of the process according to the present invention that those primary amino moieties of the respective backbone, which are reacted first with at least one lactone and/or at least one hydroxy carbon acid are transferred into an amido moiety wherein one of the originally two hydrogen atoms of the respective primary amino moiety is replaced by a fragment originating from the respective lactone or hydroxy carbon acid, whereas the second hydrogen atom of the primary amino moiety of the backbone does not get substituted by this reaction. Beyond that, such a second hydrogen atom of the primary amino moiety of the backbone does also not become substituted within the further reaction steps, e.g., further reactions with AO, LA and/or HA.

It is to be emphasized that the reactions leading to the PPI are statistical reactions, meaning there is never just one chemically exactly defined compound present, but an inventive PPI always is a mixture of slightly deviating structures, all stemming from the same reaction within one reaction space; the difference of those structures clearly stemming from the facts that no reaction proceeds in exactly the same way and the same speed on all functional units, especially as the chemical reactivities of the functional units—here mainly those of the NH-functionalities, differs according to their environment, meaning that a primary amino group reacts differently than a secondary amine and that differently compared to a tertiary amino group (specifically in terms of reaction with a lactone and/or a hydroxy carbon acid, as described above), and also the chemical environment of those three principal groups may be different in the monomers employed; this leads in an overall view to slightly deviating structures being present, and thus any PPI of this invention being defined as in the various embodiments including the numbered Embodiments 1 to 35, and exemplified in the examples never is just one chemical compound, but always a mixture of slightly deviating compounds, having a statistical distribution. As the reactivities of those groups are not differing by a large extent, the deviation is relatively small. Hence, defining a PPI by their monomers is a viable way of defining the structures. Also, defining the composition of the side chains by average numbers (including those variables defined in the following Embodiment 14) based on the numbers of NH-functionalities being present in the PPI—such number of functionalities being themselves an average number due to this factual mixture—is a useful way of defining the overall composition of any mixture herein defined as “a PPI”.

Therefore, unless otherwise indicated, the values, ranges and ratios given in the specification for a, b, c, d, and e, the number of NH-functionalities, and the molecular weight (Mn) relate to the number average values of the mixture obtained as PPI containing individual, slightly from each other deviating chemical structures of several PPI-compounds, with “the PPI” defining this mixture being the result from the preparation method. As known in polymer science, the weight-average molecular weight (Mw) is then a measure for the (in)homogeneity within the mixture of different species in “the PPI”.

Suitable lactones and/or hydroxy carbon acids can be aliphatic, cycloaliphatic or aromatic.

Particularly suitable aromatic hydroxy carbon acids are hydroxy-substituted benzoic acids and naphthalene carboxylic acids, such as p-hydroxyethyl benzoic acid and 2-hydroxynaphthalene-6-carboxylic acid. Preference is given to aliphatic hydroxy carbon acids, especially to those with hydroxyl groups in the ω position, and their lactones. In general, the aliphatic hydroxy carbon acids have from 1 to 22 alkylene radicals, preferably from 2 to 10 alkylene radicals, more preferably from 2 to 5 alkylene radicals. The alkylene radicals may be linear or branched. Examples which may be mentioned are glycolic acid, lactic acid and its lactide, gamma-hydroxybutyric acid and gamma-butyrolactone, delta-hydroxyvaleric acid and gamma- and delta-valerolactone, epsilon-hydroxycaproic acid and epsilon-caprolactone, 12-hydroxystearic acid and ricinoleic acid, and also mixtures, especially including naturally occurring acids. Preferably, glycolic acid, lactic acid, epsilon-caprolactone or lactide, or mixtures thereof, are employed, even more preferably epsilon-caprolactone.

### Embodiment 14

PPI according to Embodiment 12 or 13, wherein the order of D and E in the side chains is preferably block order, and wherein the side chains are comprising at least one of the following structural orders
i) [PPI]—N-(E1)a-(D1)d-(E2)b-(E3)c
ii) [PPI]—N-(D1)d-(E2)b-(E3)c
iii) [PPI]—N-(E1)a-(D1)d-(E2)b
iv) [PPI]—N-(D1)d-(E2)b
v) [PPI]—N-(E1)a-(D1)d-(E2)b-(D2)e
vi) [PPI]—N-(D1)d-(E2)b-(D2)e
   with (E1), (E2), (E3) each denoting sub-units each being independently from each other composed of monomers which is/are at least one alkylene oxide, preferably a single alkylene oxide,
   with (D1) and (D2) each denoting sub-units each being independently from each other composed of monomers which is/are at least one lactone(s) and/or hydroxy carbon acid(s), preferably a single lactone and/or hydroxy carbon acid
   with a, b, c, d and e defining the total average number of individual repeating units within each sub-unit (E1), (E2, (E3), (D1) and (D2)
   preferably the side chains being selected from i), ii), iii) and iv), more preferably from i) and ii), most preferably i),
   and with the variables being based on average mol equivalents per NH-functionality of the PPI as follows:
a 0.5-2, preferably 0.8-1.5, and/or
b 10 to 40, preferably 15 to 35, and/or
c 5 to 40, preferably 10 to 35, and/or
d 0.5-5, preferably 1.0-3.0, and/or
e 2-10, preferably 2-6
   preferably
   D1 is a linear or branched C3-C11 aliphatic lactone, most preferably caprolactone, and/or a hydroxy carbon acid, most preferably lactic acid and/or glycolic acid; in one preferred embodiment D1 is caprolactone;
   D2 is a linear or branched C3-C11 aliphatic lactone, most preferably caprolactone, and/or a hydroxy carbon acid, most preferably lactic acid and/or glycolic acid; in one preferred embodiment D2 is caprolactone;
   E1 is preferably C2-C5-AO, most preferably PO and/or BuO;
   E2 is C2-C5-AO containing more than 50 wt % EO, preferably more than 90 wt % EO, most preferably 100 wt % EO;
   E3 is C2-C5-AO containing more than 50 wt % PO and/or BuO, preferably more than 90 wt % PO and/or BuO, most preferably 100 wt % PO and/or BuO; in one preferred embodiment, E3 is 100 wt % PO.

It is to be emphasized that it is a preferred embodiment to employ the various AOs denoted in this previous Embodiment 14 as E1, E2 and E3, and the lactones/hydroxy carbon acids denoted in this previous Embodiment 14 as D1 and D2 in a stepwise manner. Such stepwise manner is to be understood that
by way of example using structural order “i) [PPI]—N-(E1)a-(D1)d-(E2)b-(E3)c”—
   to obtain such structural order the following reaction steps are to be employed:

A PPI as defined in this invention is employed and reacted first with AO(s) represented by E1, then in a second reaction with lactone(s)/hydroxy acid(s) represented by D1, then in a third reaction with AO(s) represented by E2, and in a fourth reaction with AO(s) represented by E3.

The conversion rate of each reaction is monitored: Only when the previous reaction (in this example: E1 as the first reactant reacting with PPI) has proceeded to a conversion rate of at least 90%, preferably at least 95%, more preferably at least 99%, and even more preferably at least 99.5% or even more has been achieved, the next reactant (in this example: D1 as the second reactant) is to be added which in turn is also monitored for its conversion rate to detect when this next reaction has proceeded to a conversion rate of at least 90%, preferably at least 95%, more preferably at least 99%, and even more preferably at least 99.5% or even more has been achieved, then the even next reaction (in this example: E2 as the third reactant) is to be added—and so on until all reactants have been reacted and the reaction of the last reactant added has proceeded to a conversion rate of at least 90%, preferably at least 95%, more preferably at least 99%, and even more preferably at least 99.5% or even more has been achieved. All other structural orders as defined in Embodiment 14 but also the undefined structures resulting from Embodiment 13 are performed in this defined manner, leading—on statistical average—to a defined structural order directly derived from the way such reaction is performed.

The conversion rate of each of the respective steps can be determined according to methods known to the skilled person, such as NMR-spectroscopy, such as 13C-NMR-spectroscopy and/or 1H-NMR-spectroscopy.

### Embodiment 15

PPI according to any of Embodiments 12 to 14, wherein the sub-units are composed as follows:
i) E1 is PO and/or BuO; and/or
ii) E2 is EO; and/or
iii) E3 is PO; and/or
iv) D1 is caprolactone; and/or
v) D2 is caprolactone,
   preferably at least two, more preferably at least three, even more preferably at least four, and most preferably all options i) to v) being interlinked with “and” and thus being required features.

### Embodiment 16

PPI according to any of Embodiments 12 to 15, wherein the sub-units are composed on average as follows:
i) E1 being 0.8-1.5 PO and/or BuO; and/or
ii) E2 being 15 to 35 of EO; and/or
iii) E3 being 10 to 35 of PO; and/or
iv) D1 being 1.0-3.0 caprolactone; and/or
v) D2 being 2-6 caprolactone,
   with all numbers being mol per NH-functionality of the PPI,
   preferably at least two, more preferably at least three, even more preferably at least four, and most preferably all options i) to v) being interlinked with “and” and thus being required features.

### Embodiment 17

PPI according to any of Embodiments 12 to 16, wherein at least 50%, preferably at least 60% and most preferably at least 80%, even more preferably at least 90, and most preferably at least 95% of all side chains attached to the NH-functionalities of one specific modified PPI have the same structural order, such structural order as being defined as “structural orders” in Embodiment 14 as i), ii), iii), iv), v) or vi).

Without wishing being bound by the following explanation, a rationale exists to explain the resulting structures of the PPI and the modified PPI: Due to the fact that the reactions in questions necessarily employed to prepare those structural orders of the side chains, and thus to prepare the specific modified PPI, are reactions of quite reactive species which can lead under suitable conditions to almost complete and even “essentially complete” conversions of almost 100% if not even 100%, the statistical deviation of the composition of the mixture of “the PPI” in question is not that high, which in turn means that the structural order of the side chains do not show much deviation. Thus, it is a reliable assumption which can in principle being proven by sophisticated and thus time-consuming and expensive analytical means—such as multi-dimensional NMR-analyses—and thus it is generally accepted that such deviation exists; hence, no “specific modified PPI” will be “just one chemical compound of a clearly defined chemical structure”, but clearly will consist of a a) mixture of slightly differing compounds, such differences lying in b) slight deviations already in the structure of compound making up “the (unmodified) PPI” being employed for the further modification steps, and c) the slight deviations in the structural orders of the side chains attached by way of d) multi-step condensation reactions due to e) variations in the chemical reactivities of the NH-functionalities, f) slight differences in the reactivities of employed AO, LA and HA due to their structure and g) due to their reactivities towards the slightly differing reactivities NH-functionalities, and h) due to slight inhomogeneities occurring in a commercial scale process. All of those factors a) to h)—to just mention a few important ones—lead to a “specific modified PPI” which is not one specific chemical compound but in fact a mixture of slightly differing compounds having an overall very similar chemical structure; thus, such structure is best described by average numbers for the variables and percentages for the amounts of the dominating structural order.

### Embodiment 18

PPI according to any of Embodiments 1 to 17, which is further modified by quaternization using standard means, including protonation by pH-adjustment or permanent quaternization by standard means such as alkylation using standard reactants, preferably by alkylation, to a degree of from 5 to 100, preferably up to 95, more preferably up to 70, even more preferably up to 50 percent of all nitrogen-atoms within the PPI.

It is well-known to a person of skill in the art that such PPI-structures and such modified PPI-structures can be quaternized using standards means, due to their in principle chemical similarity with already known structures of this general type, and the known ability to modify those known structures by quaternization.

Clearly, also the present structures described herein as PPI and modified PPI can be quaternized as well.

A suitable degree of quaternization is up to 100%, in particular from 5 to 95%. The quaternization is conducted preferably by introducing C1-C22-alkyl groups, C1-C4-alkyl groups and/or C7-C22-aralkyl groups and may be undertaken in a customary manner by reaction with corresponding alkyl halides and dialkyl sulfates.

The quaternization may be advantageous in order to adjust the inventive PPlto the particular composition such as laundry compositions in which they are to be used, and to achieve better compatibility and/or phase stability of the formulation.

The quaternization of the inventive PPI is achieved preferably by introducing C1-C22 alkyl, C1-C4-alkyl groups and/or C7-C22 aralkyl, aryl or alkylaryl groups and may be undertaken in a customary manner by reaction with corresponding alkyl-, aralkyl-halides and dialkylsulfates, as described for example in WO 09/060059.

Quaternization can be accomplished, for example, by reacting an inventive PPlwith an alkylation agent such as a C1-C4-alkyl halide, for example with methyl bromide, methyl chloride, ethyl chloride, methyl iodide, n-butyl bromide, isopropyl bromide, or with an aralkyl halide, for example with benzyl chloride, benzyl bromide or with a di-C1-C22-alkyl sulfate in the presence of a base, especially with dimethyl sulfate or with diethyl sulfate. Suitable bases are, for example, sodium hydroxide and potassium hydroxide.

The amount of alkylating agent determines the amount of quaternization of the amino groups in the polymer, i.e., the amount of quaternized moieties.

The amount of the quaternized moieties can be calculated from the difference of the amine number in the non-quaternized amine and the quaternized amine. The amine number can be determined according to the method described in DIN 16945.

The quaternization can be carried out without any solvent. However, a solvent or diluent like water, acetonitrile, dimethylsulfoxide, N-methylpyrrolidone, etc. may be used. The reaction temperature is usually in the range from 10° C. to 150° C. and is preferably from 50° C. to 100° C.

The quaternization may be advantageous in order to adjust the modified or unmodified PPI to the particular composition such as laundry compositions in which they are to be used, and to achieve better compatibility and/or phase stability of the formulation

### Embodiment 19

Process to produce a PPI according to any of the previous Embodiments 1 to 18 comprising the following steps
step a) of reacting at least one monomer (A) and/or at least one monomer (B) and/or at least one monomer (C), preferably reacting at least one monomer (A) and/or at least one monomer (B) and optionally at least one monomer (C), in a polycondensation reaction to obtain the PPI, wherein
   monomer (A) is represented by the following formula

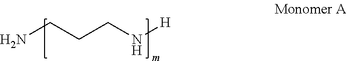

with m being selected from an integer of from 1 and up to 5,
monomer (B) is represented by the following formula

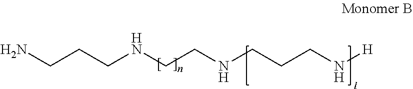

with n being selected from an integer of from 1, 3, 4 and 5, and
with l being selected from 0 or 1,
and
   monomer (C) is represented by the following formula

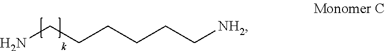

with k being selected from an integer of from 1 and up to 7,
   to obtain a PPI having at least one of the following properties:
i) containing only at least one monomer selected from i) A, ii) B, iii) A and B, iv) A and C, v) B and C, vi) A and B and C, or vii) C, preferably i) A, ii) B, iii) A and B, iv) A and C, more preferably i) A and iii) A and B, and most preferably iii) A and B;
ii) having a weight-average molecular weight Mw of below 700 g/mol, and preferably of at least 300 g/mol;
iii) having a number-average molecular weight Mn from 200 to 400 g/mol and a weight-average molecular weight Mw from 300 to below 700 g/mol;
iv) having a polydispersity index (PDI) of from 1.3 to 2.5, preferably 1.5 to 2.0;
v) comprising on average at least 6 nitrogen atoms and at most 12 nitrogen atoms;
vi) being predominantly linear, more preferably at least to 90% linear, and more preferably essentially linear such as completely linear; and/or
vii) containing no tertiary amino group (before further modification as defined in following Embodiments).

All of the terms within Embodiment 19 have been already defined and explained in detail herein before within the description of the Embodiments 1 to 18, such terms and definitions of course apply to this Embodiment 19 and the following embodiments 20 to 22, 22a and 22b as well in the same manner.

### Embodiment 20

Process according to Embodiment 19, wherein the process comprises a further step b), wherein the PPI obtained in step (a) is further modified in a further polycondensation or polyaddition reaction to produce a modified PPI comprising at least one side chain attached to at least one NH-functionality of the PPI, such chain consisting of moieties stemming from the polycondensation or polyaddition of at least one of the following further monomers
(D) at least one lactone and/or at least one hydroxy carbon acid, and/or
(E) at least one alkylene oxide being selected from C2 to C22-alkylene oxides, preferably C2 to C6, more preferably C2, C3 and/or C4,
   by reacting the PPI with D and E by employing component(s) D and E as mixture, after-each other or with overlapping addition, preferably after each other as stepwise addition when the reaction with the first added reactant has proceeded to a conversion rate of at least 90%, preferably at least 95%, more preferably at least 99%, and even more preferably at least 99.5% or even more has been achieved such as has essentially ceased to react,
   to preferably obtain the order as defined hereinafter as “structural orders” i) to vi) to produce at least one side chain having a block structure selected from the following group i) to vi) with
i) [PPI]—N-(E1)a-(D1)e-(E2)b-(E3)c
ii) [PPI]—N-(D1)e-(E2)b-(E3)c
iii) [PPI]—N-(E1)a-(D1)e-(E2)b
iv) [PPI]—N(D1)e-(E2)b
v) [PPI]—N-(E1)a-(D1)e-(E2)b-(D2)f
vi) [PPI]—N-(D1)e-(E2)b-(D2)f
   with (E1), (E2), (E3), each independently being a single or multiple alkylene oxide(s), preferably a single alkylene oxide,
   with (D1) and (D2) each independently being a single or multiple lactone(s) and/or hydroxy carbon acid(s), preferably a single lactone and/or hydroxy carbon acid,
   with (E1)a, (E2)b, (E3)c, and (D1)e, (D2)f each denoting a block made from such starting material, wherein each block could be made up of more than one alkylene oxide or lactone(s) and/or hydroxy carbon acid(s), respectively, and thus within such block containing more than one alkylene oxide or lactone(s) and/or hydroxy carbon acid(s), the order is in random version,
   preferably the side chains having a structural order selected from i), ii), iii) and iv), more preferably from i) and ii), most preferably i).

It has to be noted within the context of the process according to the present invention that those primary amino moieties of the respective backbone, which are reacted within the first reaction step of modification step (b) with at least one lactone and/or at least one hydroxy carbon acid are transferred into an amido moiety wherein one of the originally two hydrogen atoms of the respective primary amino moiety is replaced by a fragment originating from the respective lactone or hydroxy carbon acid, whereas the second hydrogen atom of the primary amino moiety of the backbone does not get substituted by this reaction. Beyond that, such a second hydrogen atom of the primary amino moiety of the backbone does also not become substituted within the further reaction steps within step (b) of the process according to the present invention when the respective intermediate backbone is for example alkoxylated with at least one C₂-C₂₂-epoxide.

### Embodiment 20a

In a preferred embodiment of the Embodiment 20, the PPI contains side chains which have a structural order being similar or—preferably—essentially identical to at least 50%, preferably at least 60% and most preferably at least 80%, even more preferably at least 90, and most preferably at least 95% of all side chains attached to the NH-functionalities of one specific modified PPI, such structural order as being defined as “structural orders” in Embodiment 20 as i), ii), iii), iv), v) or vi).

### Embodiment 21

Process according to Embodiment 20 or its preferred Embodiment 20 a, wherein the monomers D and E are defined as follows:
D=at least one lactone and/or at least one hydroxy carbon acid, and
E=at least one alkylene oxide being selected from C2 to C22-alkylene oxides, preferably C2 to C6, more preferably C2, C3 and/or C4,
   preferably
   D1 being a linear or branched C3-C11 aliphatic lactone, most preferably caprolactone, and/or a hydroxy carbon acid, most preferably lactic acid and/or glycolic acid; in one preferred embodiment D1 being caprolactone; and/or
   D2 being a linear or branched C3-C11 aliphatic lactone, most preferably caprolactone, and/or a hydroxy carbon acid, most preferably lactic acid and/or glycolic acid; in one preferred embodiment D2 being caprolactone; and/or
   E1 being preferably C2-C5-AO, most preferably PO and/or BuO; and/or
   E2 being C2-C5-AO containing more than 50 wt % EO, preferably more than 90 wt % EO, most preferably 100 wt % EO; and/or
   E3 being C2-C5-AO containing more than 50 wt % PO and/or BuO, preferably more than 90 wt % PO and/or BuO, most preferably 100 wt % PO and/or BuO; in one preferred embodiment E3 being 100 wt % PO,
   preferably at least two, more preferably at least three, even more preferably at least four, and most preferably all options for E1, E2, E3, D1 and D2 being interlinked with “and” and thus being required features.

### Embodiment 22

Process according to Embodiment 20, 20a or 21, wherein the variables as defined in Embodiment 20 are average numbers being based on mol equivalents per NH-functionality of the PPI as follows:
a 0.5-2, preferably 0.8-1.5, and/or
b 10 to 40, preferably 15 to 35, and/or
c 5 to 40, preferably 10 to 35, and/or
d 0.5-5, preferably 1.0-3.0, and/or
e 2-10, preferably 2-6

### Embodiment 22a

PPI according to any of Embodiments 20 to 22 (including Embodiment 20a), wherein the sub-units are composed as follows:
i) E1 is PO and/or BuO; and/or
ii) E2 is EO; and/or
iii) E3 is PO; and/or
iv) D1 is caprolactone; and/or
v) D2 is caprolactone,
   preferably at least two, more preferably at least three, even more preferably at least four, and most preferably all options i) to v) being interlinked with “and” and thus being required features.

### Embodiment 22b

PPI according to any of Embodiments 20 to 22 (including Embodiment 20a and 22a), wherein the sub-units are composed on average as follows:
i) E1 being 0.8-1.5 PO and/or BuO; and/or
ii) E2 being 15 to 35 of EO; and/or
iii) E3 being 10 to 35 of PO; and/or
iv) D1 being 1.0-3.0 caprolactone; and/or
v) D2 being 2-6 caprolactone,
with all numbers being mol per NH-functionality of the PPI,
preferably at least two, more preferably at least three, even more preferably at least four, and most preferably all options i) to v) being interlinked with “and” and thus being required features.

For the reaction conditions such as catalysts, temperatures, duration, purification etc. of the condensation reactions to produce the units of E1, E3, E3, D1, and D2 as part of the side chains of the PPI, the respective information within the disclosures WO 2021/165468 and unpublished patent applications EP 21176904.7, EP 21176906.2, EP 21192170.5 and EP 21192169.7 is fully encompassed into this recent disclosure by way of reference.

### Embodiment 23

Process according to any of Embodiments 19 to 22b (including 20a and 22a), wherein in step a) the catalyst employed for the reaction with hydrogen
a) comprises cobalt and/or manganese, and/or
b) is a fixed bed catalyst, and/or
c) wherein the reaction temperature during the reaction with hydrogen is in the range from 50 to 200° C., and/or
d) wherein the pressure during the reaction with hydrogen is from 30 to 100 bar;
   wherein preferably the catalyst employed comprises at least one additional metal, in particular comprises additionally aluminium, and the catalyst is a Raney-type catalyst, more preferably a Raney-Nickel or a Raney-Cobalt-catalyst which preferably comprises aluminium,
   and wherein preferably at least two, more preferably at least three, and most preferably all options a) to d) being interlinked with “and” and thus being required features.

Any suitable catalyst can in principle be used, not only the ones being explicitly highlighted as preferred features in the previous Embodiment 23. Catalysts to be used for preparing the PPI are in principle well-known. Further suitable catalysts and their preparation, suitable pre-conditioning, confectioning in certain forms etc, and ways of employing such catalysts for similar polycondensation reactions as the ones in this present invention are disclosed in WO2014131649, from page 11, line 24 to 20, line 29. All of them are in principle usable as well for this present invention, and—hence—in a further embodiment any one of the catalysts disclosed and referenced in this mentioned publication and any method of employing, catalyst preparation, catalyst pre-conditioning, catalyst confectioning in certain forms etc can be employed as well. As preferred embodiment however the Embodiment 23 defines such preferred features.

### Embodiment 24

Process according to any of Embodiment 19 to 23 (including all further Embodiments denoted with “a” and “b” as well), wherein the PPI is further submitted to the following process steps of
a) quaternization using standard means, including protonation by pH-adjustment or permanent quaternization by standard means such as alkylation using standard reactants, preferably by alkylation, to a degree of from 5 to 100, preferably up to 95, more preferably up to 70, even more preferably up to 50 percent of all nitrogen-atoms within the PPI; and/or
b) purification using standard means such as steam distillation, thermal distillation, vacuum evaporation, including removal of all solvent, and/or
c) drying using standard drying means such as spray-, drum, paddle-vacuum-drying means including agglomeration methods such as fluidized-bed-drying,
   to obtain a purified (quaternized) polymer solution, a purified liquid (quaternized) polymer, a solid (quaternized) polymer or a purified solid (quaternized) polymer, respectively.

In case that after the reaction leading to the PPI residual monomers are present to a non-desirable extent, the resulting product mixture containing the PPI may be further purified by standard means to reduce the content of residual monomers, but also to reduce the amount of possible by-products, reduce the amount(s) of the solvent(s) employed (i.e., to concentrate) or replace solvent(s) with other solvents. Such processes are known to a person of skill in this field.

Preferably, undesirable amounts of residual non-reacted monomers are removed, preferably by means of distillative processes, more preferably by thermal distillative processes, which may additionally comprise the application of reduced pressure to increase the speed and/or the effectiveness of the removal.

In a preferred embodiment of Embodiment 24, only the additional process step b) of Embodiment 24 is employed.

### Use of and Compositions Comprising PPI

Part of this invention is also the use of the inventive PPI for various fields of applications, where they can replace currently known similar structures, but bring in their enhanced rate of biodegradation compared to those previously known structures.

### Embodiment 25

Use of at least one PPI according to any one of Embodiments 1 to 18 or producible or produced by a process according to any of Embodiments 19 to 24 in
a) cleaning compositions, preferably as additive for liquid, solid or semi-solid detergent formulations, particularly for liquid detergent formulations, preferably concentrated liquid detergent formulations or single mono doses laundry detergent formulations, or liquid hand dish washing detergent formulations or solid automatic dish washing formulations;
b) in fabric and home care products,
c) in formulations for electro plating;
d) in cementitious compositions;
e) in agrochemical formulations, preferably as dispersant;
f) as adhesion promoters, for example for printing inks for laminate films;
g) as an assistant (adhesion), for example for production of multilayer composite films, with compatibilization not just of different polymer layers but also of metal foils;
h) as adhesion promoters for adhesives, for example in conjunction with polyvinyl alcohol, butyrate and acetate and styrene copolymers, or as a cohesion promoter for label adhesives;
i) as a primer in coatings applications for improvement of adhesion on substrates such as glass, wood, plastic and metal;
j) for improvement of wet adhesion, for example in standard emulsion paints, and for improvement of instantaneous rain resistance of paints, for example for road markings;
k) as complexing agents, especially with high binding capacity for heavy metals such as Hg, Pb, Cu, Ni;
l) as a flocculant, for example in water treatment/water processing;
m) as a penetration aid, for example for active metal salt formulations in wood protection;
n) as corrosion inhibitors, for example for iron and nonferrous metals, and in the sectors of petroleum production and of secondary oil production;
o) for immobilization of proteins and enzymes; microorganisms or as immobilizing supports of enzymes and microorganisms;
p) for blocking and sealing, for example mineral oil and natural gas industry;
q) as fixatives, for example in the textile industry, especially as formaldehyde-free cofixers;
r) as an additive in the cosmetic formulations, for example for hair-setting compositions and hair rinses;
s) as an assistant in the papermaking industry, for example for acceleration of dewatering, elimination of contraries, neutralization of charge and paper coating as a multipurpose assistant;
t) for separation of oil and water, for example in the metalworking industry;
u) as an additive for landfill seals;
v) as a flocculant;
w) as a swimming pool algicide;
x) for production of bitumen chemicals by reaction with fatty acids;
y) as an antiswelling agent in order that clay absorbs water in a retarded manner;
z) as an emulsifier or emulsion breaker;
aa) as a surfactant in the industrial cleaning (IC) sector;
bb) as a wood protector;
cc) for preparation of complexing agents (polycarboxylates);
dd) for production of assistants for ore mining and mineral processing;
ee) as a dispersant for pigments, ceramic, carbon black, carbon, carbon fibers, metal powders, such as emulsifier or dispersant for inks for e.g. ink jet printing;
ff) for gas scrubbing as an absorbent of CO2, NOX, SOX, Cl2 and aldehydes, and for neutralization of acidic constituents;
gg) for water softening;
hh) as a crystallization inhibitor in e.g. agrochemical formulations, oil-field uses; ii) as a rheology modifier (thickener);
jj) as an assistant or as a component for assistants for the extraction and processing of oil, coal and natural gas;
kk) for production of synthetic rubber and rubber chemicals;
ll) as an additive in coolants, lubricants and cooling lubricants;
mm) as assistants in the construction chemicals sector;
nn) as a constituent of galvanizing baths; or
oo) for production of nonviral gene vectors.

A subject matter of the present invention is the use of the above-mentioned PPI (including the modified PPI) in fabric and home care products, in cosmetic formulations, as crude oil emulsion breaker, in pigment dispersions for ink jet inks, in formulations for electro plating, in cementitious compositions and/or as dispersant for agrochemical formulations, preferably in cleaning compositions and/or in fabric and home care products, in particular cleaning compositions for improved oily and fatty stain removal, wherein the cleaning composition is preferably a laundry detergent formulation and/or a manual dish wash detergent formulation, more preferably a liquid laundry detergent formulation and/or a liquid manual dish wash detergent formulation.

The PPI can be added to cosmetic formulations, as crude oil emulsion breaker, in pigment dispersions for ink jet inks, formulations for electro plating, in cementitious compositions. However, the inventive compounds can also be added to (used in) washing or cleaning compositions.

Another subject-matter of the present invention is, therefore, a cleaning composition, fabric and home care product, industrial and institutional cleaning product, cosmetic formulation, crude oil emulsion breaker, pigment dispersion for ink jet inks, formulation for electro plating, cementitious composition and/or dispersant for agrochemical formulations, comprising at least one PPI, as defined above.

Preferably, it is a cleaning composition and/or fabric and home care product, comprising at least one PPI, as defined above, preferably for improved oily and fatty stain removal, preferably a laundry detergent formulation and/or a manual dish wash detergent formulation, more preferably a liquid laundry detergent formulation and/or a liquid manual dish wash detergent formulation.

In another preferred embodiment of the present invention, the cleaning composition may be used for soil removal of particulate stains and/or oily and fatty stains, and additionally for whiteness maintenance, preferably in laundry care.

In another embodiment, the cleaning composition of the present invention is a hard surface cleaning composition that may be used for cleaning various surfaces such as hard wood, tile, ceramic, plastic, leather, metal, glass.

In another embodiment, the cleaning composition of the present invention is a liquid or solid automatic dish wash detergent composition, preferably a solid automatic dish wash detergent composition, that may be used for cleaning dish ware, e.g., dish ware such as glasses, wherein the inventive PPI is preventing the corrosion of glass surfaces.

In another embodiment, the cleaning composition is designed to be used in personal care and pet care compositions such as shampoo compositions, body wash formulations, liquid or solid soaps.

In this invention, a preferred area of application for the use of the PPI is the field of fabric and home care products and cleaning compositions, preferably cleaning compositions for industrial and institutional use and the use by consumers in their household.

### Embodiment 26

The use according to Embodiment 25 in cleaning compositions and/or in fabric and home care products, preferably in liquid and solid detergent compositions, such detergent compositions preferably being
a) manual and automatic dish wash detergent compositions, comprising the at least one PPI, and the at least one chelating agent and/or the at least one surfactant or—more preferably—a chelating agent in case of a liquid or solid automatic dish wash composition and a surfactant system in case of a liquid manual dish wash detergent composition, respectively; and/or
b) laundry detergent compositions comprising the at least one PPI, and at least one surfactant or—preferably—a surfactant system.

Within such preferred application areas of use, typical tasks have to be fulfilled, all of which are commonly encompassed by the term “cleaning”, but in fact comprise different tasks such as removing oily and fatty residues, solid residues, amphiphilic residues and hydrophilic residues. Other tasks are the protection of the goods to be cleaned from deterioration, such as protecting glass from corroding, silverware from oxidation, colours from fading etc. Other tasks are improving the overall appearance of the to be cleaned goods, such as increasing or restoring the colour, the whiteness, imparting or increasing a shine. For many such applications additional ingredients are typically added, for cleaning applications important ones are for example enzymes, which help biologically to degrade residues.

### Embodiment 27

The use according to any of Embodiments 25 to 26 for
i) improved removal of oily/fatty stains, and/or
ii) clay removal, and/or
iii) soil removal of particulate stains, and/or
iv) dispersion and/or emulsification of soils, and/or
v) modification of treated surface to improve removal upon later re-soiling, and/or
vi) prevention or reduction, preferably prevention, of glass corrosion, and/or
vii) whiteness improvement, and/or
viii)—when at least one enzyme selected from the list consisting of lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types, more preferably at least one enzyme being selected from proteases, is present—additionally for improvement of removal of oily/fatty stains, food stain removal and/or removal of complex stains,
   most preferably in cleaning compositions for i) Improved removal of oily/fatty stains,
   each of the before mentioned options i) to viii) preferably for use in a laundry detergent formulation and/or a dish wash detergent formulation, more preferably in a liquid laundry detergent formulation, and/or an—preferably solid—automatic dish wash detergent or a liquid manual dish wash detergent formulation.

### Embodiment 28

The use according to any of Embodiments 25 to 27 in cleaning compositions and/or in fabric and home care products, preferably in cleaning compositions for in fabric and home care, the cleaning composition preferably being a laundry detergent formulation or a dish wash detergent formulation.

Such ingredients are typically formulated with other ingredients in formulations and compositions, which may be also called “products” (as they are provided from a supplier as a formulation to another customer who uses such formulation directly for cleaning purposes etc. or for producing another formulation, which in turn could be sold to consumers as a “product” to be used by the consumer.

### Embodiment 29

A composition that is a fabric and home care product, cleaning composition, industrial and institutional cleaning product, cosmetic or personal care product, oil field-formulation such as crude oil emulsion breaker, pigment dispersion for inks such as ink-jet inks, electro plating product, cementitious composition, lacquer, paint, agrochemical formulation, preferably a laundry detergent, a dish wash composition, a cleaning composition and/or a fabric and home care product, each comprising at least one PPI according to any of the Embodiments 1 to 18 or obtained by or obtainable by a process according to any of Embodiments 19-24.

### Embodiment 30

A composition according to Embodiment 29 being a solid or liquid laundry detergent composition or a solid or liquid manual dish wash detergent composition, preferably a liquid laundry detergent or manual dish wash detergent composition, more preferably a liquid laundry detergent composition, comprising the least one PPI, preferably the at least one (modified) PPI according to any one of claims 5 to 7 and according to claim 9;
optionally further comprising at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate lyases, pectinases, lactases, pectate lyases, mannanases and peroxidases, and combinations of at least two of the foregoing types, preferably at least one enzyme being selected from proteases,
optionally containing at least one antimicrobial agent,
wherein the at least one PPI is present in an amount ranging from about 0.01% to about 20%, preferably from about 0.05% to 15%, more preferably from about 0.1% to about 10%, and most preferably from about 0.5% to about 5%, in relation to the total weight of such composition or product, and
such product or composition further comprising from about 1% to about 70% by weight of at least one surfactant, preferably an anionic surfactant, or even more preferably of a surfactant system comprising at least one anionic surfactant.

### Embodiment 31

A composition according to Embodiment 29 being a solid or liquid automatic dish wash detergent composition, preferably a solid automatic dish wash detergent composition, comprising the at least one (unmodified) PPI according to any one of claims 1 to 4 and according to claim 8;

optionally further comprising at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate Iyases, pectinases, lactases, pectate lyases, mannanases and peroxidases, and combinations of at least two of the foregoing types, preferably at least one enzyme being selected from proteases and amylases,
optionally containing at least one antimicrobial agent,
optionally containing at least one compound selected from alkali metal percarbonate, alkali metal perborate and alkali metal persulfate,
optionally containing at least one zinc salt,
wherein the at least one (unmodified) PPI is being present in a total amount ranging from about 0.001% to about 10%, preferably from about 0.005% to 5%, more preferably from about 0.01% to about 3%, and most preferably from about 0.1% to about 2%, and such product or composition further comprising at least one chelating agent being present in a total amount from about 1% to about 70%, preferably from 10% to about 60% and even more preferably from 30% to about 50%, and
optionally further comprising at least one surfactant or more preferably a surfactant system in a total amount of from about 1% to about 70% by weight,
all weight percent in relation to the total weight of such composition.

### Embodiment 31a

A composition according to Embodiment 31, being a solid automatic dish wash detergent composition, comprising the at least one (unmodified) PPI according to any one of claims 1 to 4 and claim 8, and

additionally comprising at least one chelating agent selected from methylglycinediaceticacid (MGDA), glutamic acid diacetate (GLDA), citric acid and salts thereof,
at least one enzyme selected from proteases and/or amylases,
at least one bleaching agent selected from alkali metal percarbonate, alkali metal perborate and alkali metal persulfate, preferably alkali metal percarbonate,
at least one non-ionic surfactant,
optionally at least one disintegrant, preferably a super-disintergrant, more preferably PVPP, and
optionally containing at least one zinc salt.

Super-disintegrants are known by a person of skill in the art, e.g. from EP1004661, EP1263814 and EP1036839, and are discussed also in Pharmaceutical Technology, Volume 2006 Supplement, Issue 5, “A Comparative Study of Current Superdisintegrants”, Oct. 1, 2006.

### Embodiment 32

Composition according to Embodiment 31 and 31a being a detergent composition, wherein the PPI is employed for preventing or reducing glass corrosion.

### Embodiment 33

Composition according to any of Embodiments 29, 30, 31 and 32 being a detergent composition, comprising as surfactant at least one anionic surfactant, and further comprising water.

### Embodiment 33a

Composition according to any of Embodiments 29, 31, 31a and 32 being a detergent composition, comprising as surfactant at least one non-ionic surfactant, and further comprising water.

### Embodiment 34

Composition according to any of Embodiments 29 to 33 and 33a being a detergent composition, comprising at least one further polymer selected from multifunctional polyethylene imines or multifunctional diamines, or mixtures thereof.

### Embodiment 35

Composition according to any of Embodiments 29 to 34 being a liquid detergent composition, comprising as surfactant at least one 2-propylheptyl ethoxylated non-ionic surfactant having an average degree of ethoxylation of from 3 to 5.

### Embodiment 36

Composition according to any one of Embodiments 29 to 35 further comprising an antimicrobial agent selected from the group consisting of 2-phenoxyethanol and 4,4′-dichoro 2-hydroxydiphenylether; preferably comprising 2-phenoxyethanol in an amount ranging from 2 ppm to 5% by weight of the composition; more preferably comprising 0.1 to 2% of phenoxyethanol or preferably comprising 4,4′-dichoro 2-hydroxydiphenylether in a concentration from 0.001 to 3%, more preferably 0.002 to 1%, even more preferably 0.01 to 0.6%, each by weight of the composition.

### Embodiment 37

Method of preserving an aqueous composition according to any one of Embodiments 29 to 35 against microbial contamination or growth, which method comprises addition of an antimicrobial agent selected from the group consisting of 2-phenoxyethanol and 4,4′-dichoro 2-hydroxydiphenylether.

It is also preferred in the present invention that the cleaning composition comprises (besides at least one PPI as described above) additionally at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, preferably selected from one or more lipases, hydrolases, amylases, proteases, cellulases and combinations of at least two of the foregoing types, more preferably at least one enzyme being selected from proteases.

Preferably, the such inventive cleaning composition is a fabric and home care product or an industrial and institutional (&l) cleaning product, preferably a fabric and home care product, more preferably a laundry detergent or manual dish washing detergent, comprising at least one inventive PPI, and optionally further comprising at least one surfactant or a surfactant system, providing improved removal, dispersion and/or emulsification of soils and/or modification of treated surfaces and/or whiteness maintenance of treated surfaces.

At least one inventive PPI as described herein (such PPI as defined before and especially in the Embodiments 1 to 18 are in this following section also termed “inventive polymer”) is present in said inventive cleaning compositions at a concentration of 0.001 to 10, preferably from about 0.005% to 5%, more preferably from about 0.01% to about 5%, and most preferably from about 0.1% to about 3%, in relation to the total weight of such composition; such cleaning composition may—and preferably does—further comprise a from about 1% to about 70% by weight of a surfactant system.

Even more preferably, the cleaning compositions of the present invention comprising at least one inventive polymer, and optionally further comprising at least one surfactant or a surfactant system, are those for primary cleaning (i.e., removal of stains) within laundry and manual dish wash applications, even more specifically, for removal of oily and fatty stains such as those on fabrics and dishware, and may additionally comprise at least one enzyme selected from the list consisting of lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types of enzymes, more preferably at least one enzyme being selected from proteases.

In one preferred embodiment, the cleaning composition of the present invention is a liquid or solid laundry detergent composition.

In another preferred embodiment, the cleaning composition of the present invention is a liquid or solid (e.g., powder or tab/unit dose) detergent composition for manual or automatic dish wash, preferably either a liquid manual dish wash detergent composition or a solid automatic dish wash composition.

In one embodiment, the inventive polymers of the present invention may be utilized in cleaning compositions comprising a surfactant system comprising C10-C15 alkyl benzene sulfonates (LAS) as the primary surfactant and one or more additional surfactants selected from non-ionic, cationic, amphoteric, zwitterionic or other anionic surfactants, or mixtures thereof.

In a further embodiment, the inventive polymers may be utilized in cleaning compositions, such as laundry detergents of any kind, and the like, comprising C8-C18 linear or branched alkyl ethersulfates with 1-5 ethoxy-units as the primary surfactant and one or more additional surfactants selected from non-ionic, cationic, amphoteric, zwitterionic or other anionic surfactants, or mixtures thereof.

In a further embodiment the inventive polymers may be utilized in cleaning compositions, such as laundry detergents of any kind, and the like, comprising C12-C18 alkyl ethoxylate surfactants with 5-10 ethoxy-units as the primary surfactant and one or more additional surfactants selected from anionic, cationic, amphoteric, zwitterionic or other non-ionic surfactants, or mixtures thereof.

In one embodiment of the present invention, the inventive polymer is a component of a cleaning composition, such as preferably a laundry or a dish wash formulation, more preferably a liquid laundry or manual dish wash formulation, that each additionally comprise at least one surfactant, preferably at least one anionic surfactant.

The selection of the additional surfactants in these embodiments may be dependent upon the application and the desired benefit.

As used herein, the articles “a” and “an” when used in a claim or an embodiment, are understood to mean one or more of what is claimed or described. As used herein, the terms “include(s)” and “including” are meant to be non-limiting, and thus encompass more than the specific item mentioned after those words.

The compositions of the present disclosure can “comprise” (i.e. contain other ingredients), “consist essentially of” (comprise mainly or almost only the mentioned ingredients and other ingredients in only very minor amounts, mainly only as impurities), or “consist of” (i.e. contain only the mentioned ingredients and in addition may contain only impurities not avoidable in an technical environment, preferably only the ingredients) the components of the present disclosure.

Similarly, the terms “substantially free of . . . ” or “substantially free from . . . ” or “(containing/comprising) essentially no . . . ” may be used herein; this means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or even less than 0.1%, or even more less than 0.01%, or even 0%, by weight of the composition.

The term “about”, as used herein, encompasses the exact number “X” mentioned as e.g. “about X %” etc., and small variations of X, including from minus 5 to plus 5% deviation from X (with X for this calculation set to 100%), preferably from minus 2 to plus 2%, more preferably from minus 1 to plus 1%, even more preferably from minus 0.5 to plus 0.5% and smaller variations. Of course, if the value X given itself is already “100%” (such as for purity etc.) then the term “about” clearly can and thus does only mean deviations thereof which are smaller than “100”.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under atmospheric pressure. In all embodiments of the present disclosure, all percentages are by weight of the total composition, unless specifically stated otherwise. All ratios are weight ratios, unless specifically stated otherwise.

Description of Cleaning Compositions, Formulations and their Ingredients

The phrase “cleaning composition” as used herein includes compositions and formulations designed for cleaning soiled material. Such compositions and formulations include those designed for cleaning soiled material or surfaces of any kind.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces.

“Compositions for Fabric and Home Care” include cleaning compositions and formulations including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation, preferably during the wash cycle of the laundering or dish washing operation, and as further detailed herein below when describing the use and application of the inventive polymers and compositions comprising such polymers.

The cleaning compositions of the invention may be in any form, namely, in the form of a liquid; a solid such as a powder, granules, agglomerate, paste, tablet, pouches, bar, gel; an emulsion; types delivered in dual- or multi-compartment containers; single-phase or multi-phase unit dose; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a user or consumer; and other homogeneous, non-homogeneous or single-phase or multiphase cleaning product forms.

The liquid cleaning compositions of the present invention preferably have a viscosity of from 50 to 10000 mPa*s; liquid manual dish wash cleaning compositions (also liquid manual “dish wash compositions”) have a viscosity of preferably from 100 to 10000 mPa*s, more preferably from 200 to 5000 mPa*s and most preferably from 500 to 3000 mPa*s at 20 1/s and 20° C.; liquid laundry cleaning compositions have a viscosity of preferably from 50 to 3000 mPa*s, more preferably from 100 to 1500 mPa*s and most preferably from 200 to 1000 mPa*s at 20 1/s and 20° C.

The liquid cleaning compositions of the present invention may have any suitable pH-value. Preferably the pH of the composition is adjusted to between 4 and 14. More preferably the composition has a pH of from 6 to 13, even more preferably from 6 to 10, most preferably from 7 to 9. The pH of the composition can be adjusted using pH modifying ingredients known in the art and is measured as a 10% product concentration in demineralized water at 25° C. For example, NaOH may be used and the actual weight % of NaOH may be varied and trimmed up to the desired pH such as pH 8.0. In one embodiment of the present invention, a pH>7 is adjusted by using amines, preferably alkanolamines, more preferably triethanolamine.

Cleaning compositions such as fabric and home care products and formulations for industrial and institutional cleaning, more specifically such as laundry and manual dish wash detergents, are known to a person skilled in the art. Any composition etc. known to a person skilled in the art, in connection with the respective use, can be employed within the context of the present invention by including at least one inventive polymer, preferably at least one polymer in amounts suitable for expressing a certain property within such a composition, especially when such a composition is used in its area of use.

One aspect of the present invention is also the use of the inventive polymers as additives for detergent formulations, particularly for liquid detergent formulations, preferably concentrated liquid detergent formulations, or single mono doses for laundry.

The cleaning compositions of the invention may—and preferably do—contain adjunct cleaning additives (also abbreviated herein as “adjuncts”), such adjuncts being preferably in addition to a surfactant system as defined before.

Suitable adjunct cleaning additives include builders, cobuilders, structurants or thickeners, clay soil removal/anti-redeposition agents, polymeric soil release agents, dispersants such as polymeric dispersing agents, polymeric grease cleaning agents, solubilizing agents, chelating agents, enzymes, enzyme stabilizing systems, bleaching compounds, bleaching agents, bleach activators, bleach catalysts, brighteners, malodor control agents, pigments, dyes, opacifiers, hueing agents, dye transfer inhibiting agents, chelating agents, suds boosters, suds suppressors (antifoams), color speckles, silver care, anti-tarnish and/or anti-corrosion agents, alkalinity sources, pH adjusters, pH-buffer agents, hydrotropes, scrubbing particles, antibacterial agents, anti-oxidants, softeners, carriers, processing aids, pro-perfumes, and perfumes.

Liquid cleaning compositions additionally may comprise—and preferably do comprise at least one of—rheology control/modifying agents, emollients, humectants, skin rejuvenating actives, and solvents.

Solid compositions additionally may comprise—and preferably do comprise at least one of—fillers, bleaches, bleach activators and catalytic materials.

Suitable examples of such cleaning adjuncts and levels of use are found in WO 99/05242, U.S. Pat. Nos. 5,576,282, 6,306,812 B1 and 6,326,348 B1.

Those of ordinary skill in the art will understand that a detersive surfactant encompasses any surfactant or mixture of surfactants that provide cleaning, stain removing, or laundering benefit to soiled material.

Hence, the cleaning compositions of the invention such as fabric and home care products, and formulations for industrial and institutional cleaning, more specifically such as laundry and manual dish wash detergents, preferably additionally comprise a surfactant system and, more preferably, also further adjuncts, as the one described above and below in more detail.

The surfactant system may be composed from one surfactant or from a combination of surfactants selected from anionic surfactants, non-ionic surfactants, cationic surfactants, zwitterionic surfactants, amphoteric surfactants, and mixtures thereof. Those of ordinary skill in the art will understand that a surfactant system for detergents encompasses any surfactant or mixture of surfactants that provide cleaning, stain removing, or laundering benefit to soiled material.

The cleaning compositions of the invention preferably comprise a surfactant system in an amount sufficient to provide desired cleaning properties. In some embodiments, the cleaning composition comprises, by weight of the composition, from about 1% to about 70% of a surfactant system. In other embodiments, the liquid cleaning composition comprises, by weight of the composition, from about 2% to about 60% of the surfactant system. In further embodiments, the cleaning composition comprises, by weight of the composition, from about 5% to about 30% of the surfactant system. The surfactant system may comprise a detersive surfactant selected from anionic surfactants, non-ionic surfactants, cationic surfactants, zwitterionic surfactants, amphoteric surfactants, and mixtures thereof.

### (a) Laundry Compositions

In laundry formulations, anionic surfactants contribute usually by far the largest share of surfactants within such formulation. Hence, preferably, the inventive cleaning compositions for use in laundry comprise at least one anionic surfactant and optionally further surfactants selected from any of the surfactant classes described herein, preferably from non-ionic surfactants and/or amphoteric surfactants and/or zwitterionic surfactants and/or cationic surfactants.

Nonlimiting examples of anionic surfactants—which may be employed also in combinations of more than one surfactant—useful herein include C9-C20 linear alkylbenzenesulfonates (LAS), C10-C20 primary, branched chain and random alkyl sulfates (AS); C10-C18 secondary (2,3) alkyl sulfates; C10-C18 alkyl alkoxy sulfates (AExS) wherein x is from 1 to 30; C10-C18 alkyl alkoxy carboxylates comprising 1 to 5 ethoxy units; mid-chain branched alkyl sulfates as discussed in U.S. Pat. Nos. 6,020,303 and 6,060,443; mid-chain branched alkyl alkoxy sulfates as discussed in U.S. Pat. Nos. 6,008,181 and 6,020,303; modified alkylbenzene sulfonate (MLAS) as discussed in WO 99/05243, WO 99/05242 and WO 99/05244; methyl ester sulfonate (MES); and alpha-olefin sulfonate (AOS).

Preferred examples of suitable anionic surfactants are alkali metal and ammonium salts of C8-C12-alkyl sulfates, of C12-C18-fatty alcohol ether sulfates, of C12-C18-fatty alcohol polyether sulfates, of sulfuric acid half-esters of ethoxylated C4-C12-alkylphenols (ethoxylation: 3 to 50 mol of ethylene oxide/mol), of C12-C18-alkylsulfonic acids, of C12-C18 sulfo fatty acid alkyl esters, for example of C12-C18 sulfo fatty acid methyl esters, of C10-C18-alkylarylsulfonic acids, preferably of n-C10-C18-alkylbenzene sulfonic acids, of C10-C18 alkyl alkoxy carboxylates and of soaps such as for example C8-C24-carboxylic acids. Preference is given to the alkali metal salts of the aforementioned compounds, particularly preferably the sodium salts.

In one embodiment of the present invention, anionic surfactants are selected from n-C10-C18-alkylbenzene sulfonic acids and from fatty alcohol polyether sulfates, which, within the context of the present invention, are in particular sulfuric acid half-esters of ethoxylated C12-C18-alkanols (ethoxylation: 1 to 50 mol of ethylene oxide/mol), preferably of n-C12-C18-alkanols.

In one embodiment of the present invention, also alcohol polyether sulfates derived from branched (i.e., synthetic) C11-C18-alkanols (ethoxylation: 1 to 50 mol of ethylene oxide/mol) may be employed.

Preferably, the alkoxylation group of both types of alkoxylated alkyl sulfates, based on C12-C18-fatty alcohols or based on branched (i.e., synthetic) C11-C18-alcohols, is an ethoxylation group and an average ethoxylation degree of any of the alkoxylated alkyl sulfates is 1 to 5, preferably 1 to 3.

Preferably, the laundry detergent formulation of the present invention comprises from at least 1 wt.-% to 50 wt.-%, preferably in the range from greater than or equal to about 2 wt.-% to equal to or less than about 30 wt.-%, more preferably in the range from greater than or equal to 3 wt.-% to less than or equal to 25 wt.-%, and most preferably in the range from greater than or equal to 5 wt.-% to less than or equal to 25 wt.-% of one or more anionic surfactants as described above, based on the particular overall composition, including other components and water and/or solvents.

In a preferred embodiment of the present invention, anionic surfactants are selected from C10-C15 linear alkylbenzenesulfonates, C10-C18 alkylethersulfates with 1-5 ethoxy units and C10-C18 alkylsulfates.

Non-limiting examples of non-ionic surfactants—which may be employed also in combinations of more than one other surfactant—include: C8-C18 alkyl ethoxylates, such as, NEODOL@ non-ionic surfactants from Shell; ethylenoxide/propylenoxide block alkoxylates as PLURONIC® from BASF; C14-C22 mid-chain branched alkyl alkoxylates, BAEx, wherein x is from 1 to 30, as discussed in U.S. Pat. Nos. 6,153,577, 6,020,303 and 6,093,856; alkylpolysaccharides as discussed in U.S. Pat. No. 4,565,647 Llenado, issued Jan. 26, 1986; specifically alkylpolyglycosides as discussed in U.S. Pat. Nos. 4,483,780 and 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408.

Preferred examples of non-ionic surfactants are in particular alkoxylated alcohols and alkoxylated fatty alcohols, di- and multiblock copolymers of ethylene oxide and propylene oxide and reaction products of sorbitan with ethylene oxide or propylene oxide, furthermore alkylphenol ethoxylates, alkyl glycosides, polyhydroxy fatty acid amides (glucamides). Examples of (additional) amphoteric surfactants are so-called amine oxides.

Preferred examples of alkoxylated alcohols and alkoxylated fatty alcohols are, for example, compounds of the general formula (A)

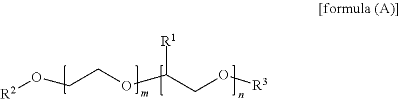

in which the variables are defined as follows:
R1 is selected from linear C1-C10-alkyl, preferably ethyl and particularly preferably methyl,
R2 is selected from C8-C22-alkyl, for example n-C8H17, n-C10H21, n-C12H25, n-C14H29, n-C16H33 or n-C18H37,
R3 is selected from C1-C10-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
m and n are in the range from zero to 300, where the sum of n and m is at least one. Preferably, m is in the range from 1 to 100 and n is in the range from 0 to 30.

Here, compounds of the general formula (A) may be block copolymers or random copolymers, preference being given to block copolymers.

Other preferred examples of alkoxylated alcohols and alkoxylated fatty alcohols are, for example, compounds of the general formula (B)

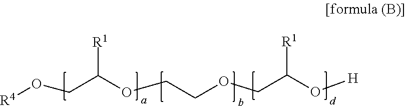

in which the variables are defined as follows:
R1 is identical or different and selected from linear C1-C4-alkyl, preferably identical in each case and ethyl and particularly preferably methyl,
R4 is selected from C6-C20-alkyl, in particular n-C8H17, n-C10H21, n-C12H25, n-C14H29, n-C16H33, n-C18H37,
a is a number in the range from zero to 6, preferably 1 to 6,
b is a number in the range from zero to 20, preferably 4 to 20,
d is a number in the range from 4 to 25.

Preferably, at least one of a and b is greater than zero.

Here, compounds of the general formula (B) may be block copolymers or random copolymers, preference being given to block copolymers.

Further suitable non-ionic surfactants are selected from di- and multiblock copolymers, composed of ethylene oxide and propylene oxide. Further suitable non-ionic surfactants are selected from ethoxylated or propoxylated sorbitan esters. Alkylphenol ethoxylates or alkyl polyglycosides or polyhydroxy fatty acid amides (glucamides) are likewise suitable. An overview of suitable further non-ionic surfactants can be found in EP-A 0 851 023 and in DE-A 198 19 187.

Mixtures of two or more different non-ionic surfactants may of course also be present.

In a preferred embodiment of the present invention, non-ionic surfactants are selected from C12/14 and C16/18 fatty alkoholalkoxylates, C13/15 oxoalkoholalkoxylates, C13-alkoholalkoxylates, and 2-propylheptylalkoholalkoxylates, each of them with 3-15 ethoxy units, preferably 5-10 ethoxy units, or with 1-3 propoxy- and 2-15 ethoxy units.

Non-limiting examples of amphoteric surfactants—which may be employed also in combinations of more than one other surfactant—include: water-soluble amine oxides containing one alkyl moiety of from about 8 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. Nos. 4,681,704, and 4,133,779. Suitable surfactants include thus so-called amine oxides, such as lauryl dimethyl amine oxide (“lauramine oxide”).

Preferred examples of amphoteric surfactants are amine oxides. Preferred amine oxides are alkyl dimethyl amine oxides or alkyl amido propyl dimethyl amine oxides, more preferably alkyl dimethyl amine oxides and especially coco dimethyl amino oxides. Amine oxides may have a linear or mid-branched alkyl moiety. Typical linear amine oxides include water-soluble amine oxides containing one R1=C8-18 alkyl moiety and two R2 and R3 moieties selected from the group consisting of C1-C3 alkyl groups and C1-C3 hydroxyalkyl groups. Preferably, the amine oxide is characterized by the formula

R1-N(R2)(R3)—O

wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the alpha carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that (n1-n2) is less than or equal to 5, preferably 4, most preferably from 0 to 4 carbon atoms in at least 50 wt.-%, more preferably at least 75 wt.-% to 100 wt.-% of the mid-branched amine oxides for use herein. The amine oxide further comprises two moieties, independently selected from a C1-C3 alkyl, a C1-C3 hydroxyalkyl group, or a polyethylene oxide group containing an average of from about 1 to about 3 ethylene oxide groups. Preferably the two moieties are selected from a C1-C3 alkyl, more preferably both are selected as a C1 alkyl.

In a preferred embodiment of the present invention, amphoteric surfactants are selected from C8-C18 alkyl-dimethyl aminoxides and C8-C18 alkyl-di(hydroxyethyl)aminoxide.

Cleaning compositions may also contain zwitterionic surfactants—which may be employed also in combinations of more than one other surfactant.

Suitable zwitterionic surfactants include betaines, such as alkyl betaines, alkylamidobetaine, amidazoliniumbetaine, sulfobetaine (INCI Sultaines) as well as the phosphobetaines. Examples of suitable betaines and sulfobetaines are the following (designated in accordance with INCI): Almond amidopropyl of betaines, Apricotamidopropyl betaines, Avocadamidopropyl of betaines, Babassuamidopropyl of betaines, Behenamidopropyl betaines, Behenyl of betaines, Canol amidopropyl betaines, Capryl/Capramidopropyl betaines, Carnitine, Cetyl of betaines, Cocamidoethyl of betaines, Cocamidopropyl betaines, Cocamidopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucamidopropyl Hydroxysultaine, Hydrogenated Tallow of betaines, Isostearamidopropyl betaines, Lauramidopropyl betaines, Lauryl of betaines, Lauryl Hydroxysultaine, Lauryl Sultaine, Milkamidopropyl betaines, Minkamidopropyl of betaines, Myristamidopropyl betaines, Myristyl of betaines, Oleamidopropyl betaines, Oleamidopropyl Hydroxysultaine, Oleyl of betaines, Olivamidopropyl of betaines, Palmamidopropyl betaines, Palmitamidopropyl betaines, Palmitoyl Carnitine, Palm Kernelamidopropyl betaines, Polytetrafluoroethylene Acetoxypropyl of betaines, Ricinoleam idopropyl betaines, Sesamidopropyl betaines, Soyamidopropyl betaines, Stearamidopropyl betaines, Stearyl of betaines, Tallowamidopropyl betaines, Tallowamidopropyl Hydroxysultaine, Tallow of betaines, Tallow Dihydroxyethyl of betaines, Undecylenamidopropyl betaines and Wheat Germamidopropyl betaines.

Preferred betaines are, for example, C12-C18-alkylbetaines and sulfobetaines. The zwitterionic surfactant preferably is a betaine surfactant, more preferable a Cocoamidopropylbetaine surfactant.

Non-limiting examples of cationic surfactants—which may be employed also in combinations of more than one other surfactant—include: the quaternary ammonium surfactants, which can have up to 26 carbon atoms include: alkoxylated quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Compositions according to the invention may comprise at least one builder. In the context of the present invention, no distinction will be made between builders and such components elsewhere called “co-builders”. Examples of builders are complexing agents, hereinafter also referred to as complexing agents, ion exchange compounds, and precipitating agents. Builders are selected from citrate, phosphates, silicates, carbonates, phosphonates, amino carboxylates and polycarboxylates.

In the context of the present invention, the term citrate includes the mono- and the dialkali metal salts and in particular the mono- and preferably the trisodium salt of citric acid, ammonium or substituted ammonium salts of citric acid as well as citric acid. Citrate can be used as the anhydrous compound or as the hydrate, for example as sodium citrate dihydrate. Quantities of citrate are calculated referring to anhydrous trisodium citrate.

The term phosphate includes sodium metaphosphate, sodium orthophosphate, sodium hydrogenphosphate, sodium pyrophosphate and polyphosphates such as sodium tripolyphosphate. Preferably, however, the composition according to the invention is free from phosphates and polyphosphates, with hydrogenphosphates being subsumed, for example free from trisodium phosphate, pentasodium tripolyphosphate and hexasodium metaphosphate (“phosphate-free”). In connection with phosphates and polyphosphates, “free from” should be understood within the context of the present invention as meaning that the content of phosphate and polyphosphate is in total in the range from 10 ppm to 0.2% by weight of the respective composition, determined by gravimetry.

The term carbonates includes alkali metal carbonates and alkali metal hydrogen carbonates, preferred are the sodium salts. Particularly preferred is Na2CO3.

Examples of phosphonates are hydroxyalkanephosphonates and aminoalkanephosphonates. Among the hydroxyalkanephosphonates, the 1-hydroxyethane-1,1-diphosphonate (HEDP) is of particular importance as builder. It is preferably used as sodium salt, the disodium salt being neutral and the tetrasodium salt being alkaline (pH 9). Suitable aminoalkanephosphonates are preferably ethylene diaminetetramethylenephosphonate (EDTMP), diethylenetriaminepenta-methylenephosphonate (DTPMP), and also their higher homologues. They are preferably used in the form of the neutrally reacting sodium salts, e.g. as hexasodium salt of EDTMP or as hepta- and octa-sodium salts of DTPMP.

Examples of amino carboxylates and polycarboxylates are nitrilotriacetates, ethylene diamine tetraacetate, diethylene triamine pentaacetate, triethylene tetraamine hexaacetate, propylene diamines tetraacetic acid, ethanol-diglycines, methylglycine diacetate, and glutamine diacetate. The term amino carboxylates and polycarboxylates also include their respective non-substituted or substituted ammonium salts and the alkali metal salts such as the sodium salts, in particular of the respective fully neutralized compound.

Silicates in the context of the present invention include in particular sodium disilicate and sodium metasilicate, alumosilicates such as for example zeolites and sheet silicates, in particular those of the formula α-Na2Si2O5, β-Na2Si2O5, and δ-Na2Si2O5.

Compositions according to the invention may contain one or more builder selected from materials not being mentioned above. Examples of builders are a-hydroxypropionic acid and oxidized starch.

In one embodiment of the present invention, builder is selected from polycarboxylates. The term “polycarboxylates” includes non-polymeric polycarboxylates such as succinic acid, C2-C16-alkyl disuccinates, C2-C16-alkenyl disuccinates, ethylene diamine N,N′-disuccinic acid, tartaric acid diacetate, alkali metal malonates, tartaric acid monoacetate, propanetricarboxylic acid, butanetetracarboxylic acid and cyclopentanetetracarboxylic acid.

Oligomeric or polymeric polycarboxylates are for example polyaspartic acid or in particular alkali metal salts of (meth)acrylic acid homopolymers or (meth)acrylic acid copolymers.

Suitable co-monomers are monoethylenically unsaturated dicarboxylic acids such as maleic acid, fumaric acid, maleic anhydride, itaconic acid and citraconic acid. A suitable polymer is in particular polyacrylic acid, which preferably has a weight-average molecular weight Mw in the range from 2000 to 40 000 g/mol, preferably 2000 to 10 000 g/mol, in particular 3000 to 8000 g/mol. Further suitable copolymeric polycarboxylates are in particular those of acrylic acid with methacrylic acid and of acrylic acid or methacrylic acid with maleic acid and/or fumaric acid. It is also possible to use copolymers of at least one monomer from the group consisting of monoethylenically unsaturated C3-C10-mono- or C4-C10-dicarboxylic acids or anhydrides thereof, such as maleic acid, maleic anhydride, acrylic acid, methacrylic acid, fumaric acid, itaconic acid and citraconic acid, with at least one hydrophilically or hydrophobically modified co-monomer as listed below.

Suitable hydrophobic co-monomers are, for example, isobutene, diisobutene, butene, pentene, hexene and styrene, olefins with ten or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C22-α-olefin, a mixture of C20-C24-α-olefins and polyisobutene having on average 12 to 100 carbon atoms per molecule.

Suitable hydrophilic co-monomers are monomers with sulfonate or phosphonate groups, and also non-ionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here can comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

Moreover, amphoteric polymers can also be used as builders.

Compositions according to the invention can comprise, for example, in the range from in total 0.1 to 70% by weight, preferably 10 to 50% by weight, preferably up to 20% by weight, of builder(s), especially in the case of solid formulations. Liquid formulations according to the invention preferably comprise in the range of from 0.1 to 8% by weight of builder.

Formulations according to the invention can comprise one or more alkali carriers. Alkali carriers ensure, for example, a pH of at least 9 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium. In one embodiment of the present invention, a pH>7 is adjusted by using amines, preferably alkanolamines, more preferably triethanolamine.

In one embodiment of the present invention, the laundry formulation according to the invention comprises additionally at least one enzyme.

Useful enzymes are, for example, one or more hydrolases selected from lipases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types, more preferably at least one enzyme being selected from proteases.

Such enzyme(s) can be incorporated at levels sufficient to provide an effective amount for cleaning. The preferred amount is in the range from 0.001% to 5% of active enzyme by weight in the detergent composition according to the invention. Together with enzymes also enzyme stabilizing systems may be used such as for example calcium ions, boric acid, boronic acid, propylene glycol and short chain carboxylic acids. In the context of the present invention, short chain carboxylic acids are selected from monocarboxylic acids with 1 to 3 carbon atoms per molecule and from dicarboxylic acids with 2 to 6 carbon atoms per molecule. Preferred examples are formic acid, acetic acid, propionic acid, oxalic acid, succinic acid, HOOC(CH2)3COOH, adipic acid and mixtures from at least two of the foregoing, as well as the respective sodium and potassium salts.

Compositions according to the invention may comprise one or more bleaching agent (bleaches).

Preferred bleaches are selected from sodium perborate, anhydrous or, for example, as the monohydrate or as the tetrahydrate or so-called dihydrate, sodium percarbonate, anhydrous or, for example, as the monohydrate, and sodium persulfate, where the term “persulfate” in each case includes the salt of the peracid H2SO5 and also the peroxodisulfate.

In this connection, the alkali metal salts can in each case also be alkali metal hydrogen carbonate, alkali metal hydrogen perborate and alkali metal hydrogen persulfate. However, the dialkali metal salts are preferred in each case.

Formulations according to the invention can comprise one or more bleach catalysts. Bleach catalysts can be selected from oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Formulations according to the invention can comprise one or more bleach activators, for example tetraacetyl ethylene diamine, tetraacetylmethylene diamine, tetraacetylglycoluril, tetraacetylhexylene diamine, acylated phenolsulfonates such as for example n-nonanoyl- or isononanoyloxybenzene sulfonates, N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Formulations according to the invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, formulations according to the invention comprise in total in the range from 0.1 to 1.5% by weight of corrosion inhibitor.

Formulations according to the invention may also comprise further cleaning polymers and/or soil release polymers.

The additional cleaning polymers may include, without limitation, “multifunctional polyethylene imines” (for example BASF's Sokalan® HP20) and/or “multifunctional diamines” (for example BASF's Sokalan® HP96). Such multifunctional polyethylene imines are typically ethoxylated polyethylene imines with a weight-average molecular weight Mw in the range from 3000 to 250000, preferably 5000 to 200000, more preferably 8000 to 100000, more preferably 8000 to 50000, more preferably 10000 to 30000, and most preferably 10000 to 20000 g/mol. Suitable multifunctional polyethylene imines have 80 wt.-% to 99 wt.-%, preferably 85 wt.-% to 99 wt.-%, more preferably 90 wt.-% to 98 wt.-%, most preferably 93 wt.-% to 97 wt.-% or 94 wt.-% to 96 wt.-% ethylene oxide side chains, based on the total weight of the materials. Ethoxylated polyethylene imines are typically based on a polyethylene imine core and a polyethylene oxide shell. Suitable polyethylene imine core molecules are polyethylene imines with a weight-average molecular weight Mw in the range of 500 to 5000 g/mol. Preferably employed is a molecular weight from 500 to 1000 g/mol, even more preferred is a Mw of 600 to 800 g/mol. The ethoxylated polymer then has on average 5 to 50, preferably 10 to 35 and even more preferably 20 to 35 ethylene oxide (EO) units per NH-functional group.

Suitable multifunctional diamines are typically ethoxylated C2 to C12 alkylene diamines, preferably hexamethylene diamine, which are further quaternized and optionally sulfated. Typical multifunctional diamines have a weight-average molecular weight Mw in the range from 2000 to 10000, more preferably 3000 to 8000, and most preferably 4000 to 6000 g/mol. In a preferred embodiment of the invention, ethoxylated hexamethylene diamine, furthermore quaternized and sulfated, may be employed, which contains on average 10 to 50, preferably 15 to 40 and even more preferably 20 to 30 ethylene oxide (EO) groups per NH-functional group, and which preferably bears two cationic ammonium groups and two anionic sulfate groups.

In a preferred embodiment of the present invention, the cleaning compositions may contain at least one multifunctional polyethylene imine and/or at least one multifunctional diamine to improve the cleaning performance, such as preferably improve the stain removal ability, especially the primary detergency of particulate stains on polyester fabrics of laundry detergents. The multifunctional polyethylene imines or multifunctional diamines or mixtures thereof according to the descriptions above may be added to the laundry detergents and cleaning compositions in amounts of generally from 0.05 to 15 wt.-%, preferably from 0.1 to 10 wt.-% and more preferably from 0.25 to 5 wt.-% and even as low as up to 2 wt. %, based on the particular overall composition, including other components and water and/or solvents.

Thus, one aspect of the present invention is a laundry detergent composition, in particular a liquid laundry detergent, comprising (i) at least one inventive polymer and (ii) at least one compound selected from multifunctional polyethylene imines and multifunctional diamines and mixtures thereof.

In one embodiment of the present invention, the ratio of the at least one inventive polymer and (ii) the at least one compound selected from multifunctional polyethylene imines and multifunctional diamines and mixtures thereof, is from 10:1 to 1:10, preferably from 5:1 to 1:5 and more preferably from 3:1 to 1:3.

Laundry formulations comprising the inventive polymer may also comprise at least one antimicrobial agent (also often named preservatives).

The composition may contain one or more antimicrobial agents and/or preservatives as listed in patent WO2021/115912 A1 on pages 35 to 39.

Especially of interest are the following antimicrobial agents and/or preservatives:

4,4′-dichloro 2-hydroxydiphenyl ether (CAS-No. 3380-30-1), further names: 5-chloro-2-(4-chlorophenoxy) phenol, Diclosan, DCPP, which is commercially avail-able as a solution of 30 wt % of 4,4′-dichloro 2-hydroxydiphenyl ether in 1,2 propyl-eneglycol under the trade name Tinosan® HP 100 (BASF); 2-Phenoxyethanol (CAS-no. 122-99-6, further names: Phenoxyethanol, Methylphenylglycol, Phenoxetol, ethylene glycol phenyl ether, Ethylene glycol monophenyl ether, Protectol® PE); 2-bromo-2-nitropropane-1,3-diol (CAS-No. 52-51-7, further names: 2-bromo-2-nitro-1,3-propanediol, Bronopol®, Protectol® BN, Myacide AS); Glutaraldehyde (CAS-No. 111-30-8, further names: 1-5-pentandial, pentane-1,5-dial, glutaral, glutardialdehyde, Protectol® GA, Protectol® GA 50, Myacide® GA); Glyoxal (CAS No. 107-22-2; further names: ethandial, oxylaldehyde, 1,2-ethandial, Protectol® GL); 2-butyl-benzo[d]isothiazol-3-one (BBIT, CAS No. 4299-07-4); 2-methyl-2H-isothiazol-3-one (MIT, CAS No 2682-20-4); 2-octyl-2H-isothiazol-3-one (OIT, CAS No. 26530-20-1); 5-Chloro-2-methyl-2H-isothiazol-3-one (CIT, CMIT, CAS No. 26172-55-4); Mixture of 5-chloro-2-methyl-2H-isothiazol-3-one (CMIT, EINECS 247-500-7) and 2-methyl-2H-isothiazol-3-one (MIT, EINECS 220-239-6) (Mixture of CMIT/MIT, CAS No. 55965-84-9); 1,2-benzisothiazol-3(2H)-one (BIT, CAS No. 2634-33-5); Hexa-2,4-dienoic acid (Sorbic acid, CAS No. 110-44-1) and its salts, e.g. calcium sorbate, sodium sorbate, potassium (E,E)-hexa-2,4-dienoate (Potassium Sorbate, CAS No. 24634-61-5); Lactic acid and its salts; L-(+)-lactic acid (CAS No. 79-33-4); Benzoic acid and its sodium salt (CAS No 65-85-0, CAS No. 532-32-1) and salts of benzoic acid e.g. ammonium benzoate, calcium benzoate, magnesium benzoate, MEA-benzoate, potassium benzoate; Salicylic acid and its salts, e.g. calcium salicylate, magnesium salicylate, MEA sa-licylate, sodium salicylate, potassium salicylate, TEA salicylate; Benzalkonium chloride, bromide and saccharinate, e.g. benzalkonium chloride, benzalkonium bromide, benzalkonium saccharinate (CAS Nos 8001-54-5, 63449-41-2, 91080-29-4, 68989-01-5, 68424-85-1, 68391-01-5, 61789-y71-7, 85409-22-9); Didecyldimethylammonium chloride (DDAC, CAS No. 68424-95-3 and CAS No. 7173-51-5); N-(3-aminopropyl)-N-dodecylpropane-1,3-diamine (Diamine, CAS No. 2372-82-9); Peracetic acid (CAS No. 79-21-0); Hydrogen peroxide (CAS No. 7722-84-1).

The antimicrobial agent is added to the composition in a concentration of 0.001 to 10% relative to the total weight of the composition.

Preferably, the composition contains 2-Phenoxyethanol in a concentration of 0.1 to 2% or 4,4′-dichloro 2-hydroxydiphenyl ether (DCPP) in a concentration of 0.005 to 0.6%.

The invention thus further encompasses a method of preserving an aqueous composition according to the invention against microbial contamination or growth, which method comprises addition of 2-Phenoxyethanol. The invention thus further encompasses a method of providing an antimicrobial effect on textiles after treatment with a solid laundry detergent e.g. powders, granulates, capsules, tablets, bars etc.), a liquid laundry detergent, a softener or an after rinse containing 4,4′-dichloro 2-hydroxydiphenyl ether (DCPP).

In a further embodiment, this invention also encompasses a composition comprising an inventive polymer as descried herein before, further comprises an antimicrobial agent as disclosed hereinafter, preferably selected from the group consisting of 2-phenoxyethanol, more preferably comprising said antimicrobial agent in an amount ranging from 2 ppm to 5% by weight of the composition; even more preferably comprising 0.1 to 2% of phenoxyethanol.

In a further embodiment, this invention also encompasses a method of preserving an aqueous composition against microbial contamination or growth, such composition comprising an inventive polymer as described herein before, such composition being preferably a detergent composition, such method comprising adding at least one antimicrobial agent selected from the disclosed antimicrobial agents as disclosed hereinafter, such antimicrobial agent preferably being 2-phenoxyethanol.

In a further embodiment, this invention also encompasses a composition, preferably a cleaning composition, more preferably a liquid laundry detergent composition or a liquid hand dish composition, even more preferably a liquid laundry detergent composition, or a liquid softener composition for use in laundry, such composition comprising an inventive polymer as described herein before, such composition further comprising 4,4′-dichoro 2-hydroxydiphenylether in a concentration from 0.001 to 3%, preferably 0.002 to 1%, more preferably 0.01 to 0.6%, each by weight of the composition.

In a further embodiment, this invention also encompasses a method of laundering fabric or of cleaning hard surfaces, which method comprises treating a fabric or a hard surface with a cleaning composition, more preferably a liquid laundry detergent composition or a liquid hand dish composition, even more preferably a liquid laundry detergent composition, or a liquid softener composition for use in laundry, such composition comprising an inventive polymer as described herein before, such composition further comprising 4,4′-dichoro 2-hydroxydiphenylether.

Formulations according to the invention may also comprise water and/or additional organic solvents, e.g., ethanol or propylene glycol.

Further optional ingredients may be but are not limited to viscosity modifiers, cationic surfactants, foam boosting or foam reducing agents, perfumes, dyes, optical brighteners, and dye transfer inhibiting agents.

### (b) Dish Wash Compositions

Another aspect of the present invention is also a dish wash composition, comprising at least one PPI (as defined in any of the embodiments herein, especially the Embodiments 1 to 18; PPI in this section also named “inventive polymer”) as described above.

Thus, an aspect of the present invention is also the use of the inventive polymer as described above, in dish wash applications, such as manual or automatic dish wash applications.

Dish wash compositions according to the invention can be in the form of a liquid, semi-liquid, cream, lotion, gel, or solid composition, solid embodiments encompassing, for example, powders and tablets. Liquid compositions are typically preferred for manual dish wash applications, whereas solid formulations and pouch formulations (where the pouches may contain also solids in addition to liquid ingredients) are typically preferred for automatic dish washing compositions; however, in some areas of the world also liquid automatic dish wash compositions are used and are thus of course also encompassed by the term “dish wash composition”.

The dish wash compositions are intended for direct or indirect application onto dishware and metal and glass surfaces, such as drinking and other glasses, beakers, dish and cooking ware like pots and pans, and cutlery such as forks, spoons, knives and the like.

The inventive method of cleaning dishware, metal and/or glass surfaces comprises the step of applying the dish wash cleaning composition, preferably in liquid form, onto the surface, either directly or by means of a cleaning implement, i.e., in neat form. The composition is applied directly onto the surface to be treated and/or onto a cleaning device or implement such as a dish cloth, a sponge or a dish brush and the like without undergoing major dilution (immediately) prior to the application. The cleaning device or implement is preferably wet before or after the composition is delivered to it. In the method of the invention, the composition can also be applied in diluted form.

Both neat and dilute application give rise to superior cleaning performance, i.e., the formulations of the invention containing at least one inventive polymer exhibit excellent degreasing properties.

The effort of removing fat and/or oily soils from the dishware, metal and/or glass surfaces is decreased due to the presence of the inventive polymer, even when the level of surfactant used is lower than in conventional compositions.

Preferably the composition is formulated to provide superior grease cleaning (degreasing) properties, long-lasting suds and/or improved viscosity control at decreased temperature exposures; preferably at least two, more preferably all three properties are present in the inventive dish wash composition. Optional—preferably present—further benefits of the inventive manual dish wash composition include soil removal, shine, and/or hand care; more preferably at least two and most preferably all three further benefits are present in the inventive dish wash composition.

In a preferred embodiment of the present invention, the inventive polymer is one component of an automatic dish wash formulation, preferably of a solid automatic dish wash formulation. The formulations comprising the inventive polymer exhibit significantly reduced glass corrosion.

In another preferred embodiment of the present invention, the inventive polymer is one component of a manual dish wash formulation that additionally comprises at least one surfactant, preferably at least one anionic surfactant.

In another embodiment of the present invention, the inventive polymer is one component of a manual dish wash formulation that additionally comprises at least one anionic surfactant and at least one other surfactant, preferably selected from amphoteric surfactants and/or zwitterionic surfactants. In a preferred embodiment of the present invention, the manual dish wash formulations contain at least one amphoteric surfactant, preferably an amine oxide, or at least one zwitterionic surfactant, preferably a betaine, or mixtures thereof, to aid in the foaming, detergency, and/or mildness of the detergent composition.

Examples of suitable anionic surfactants are already mentioned above for laundry compositions.

Preferred anionic surfactants for manual dish wash compositions are selected from C10-C15 linear alkylbenzenesulfonates, C10-C18 alkylethersulfates with 1-5 ethoxy units and C10-C18 alkylsulfates.

Preferably, the manual dish wash detergent formulation of the present invention comprises from at least 1 wt.-% to 50 wt.-%, preferably in the range from greater than or equal to about 3 wt.-% to equal to or less than about 35 wt.-%, more preferably in the range from greater than or equal to 5 wt.-% to less than or equal to 30 wt.-%, and most preferably in the range from greater than or equal to 5 wt.-% to less than or equal to 20 wt.-% of one or more anionic surfactants as described above, based on the particular overall composition, including other components and water and/or solvents.

Dish wash compositions according to the invention, preferably manual dish wash compositions, may comprise at least one amphoteric surfactant.

Examples of suitable amphoteric surfactants for dish wash compositions are already mentioned above for laundry compositions.

Preferred amphoteric surfactants for dish wash compositions are selected from C8-C18 alkyl-dimethyl aminoxides and C8-C18 alkyl-di(hydroxyethyl)aminoxide.

The manual dish wash detergent composition of the invention preferably comprises from 1 wt.-% to 15 wt.-%, preferably from 2 wt.-% to 12 wt.-%, more preferably from 3 wt.-% to 10 wt.-% of the composition of an amphoteric surfactant, preferably an amine oxide surfactant. Preferably the composition of the invention comprises a mixture of the anionic surfactants and alkyl dimethyl amine oxides in a weight ratio of less than about 10:1, more preferably less than about 8:1, more preferably from about 5:1 to about 2:1.

Addition of the amphoteric surfactant provides good foaming properties in the dish wash composition.

Dish wash compositions according to the invention, preferably manual dish wash compositions, may comprise at least one zwitterionic surfactant.

Examples of suitable zwitterionic surfactants for dish wash compositions are already mentioned above for laundry compositions.

Preferred zwitterionic surfactants for dish wash compositions are selected from betaine surfactants, more preferable from Cocoamidopropylbetaine surfactants.

In a preferred embodiment of the present invention, the zwitterionic surfactant is Cocamidopropylbetaine.

The manual dish wash detergent composition of the invention optionally comprises from 1 wt.-% to 15 wt.-%, preferably from 2 wt.-% to 12 wt.-%, more preferably from 3 wt.-% to 10 wt.-% of the composition of a zwitterionic surfactant, preferably a betaine surfactant.

Dish wash compositions according to the invention, preferably manual dish wash compositions, may comprise at least one cationic surfactant.

Examples of suitable cationic surfactants for dish wash compositions are already mentioned above for laundry compositions.

Cationic surfactants, when present in the composition, are present in an effective amount, more preferably from 0.1 wt.-% to 5 wt.-%, preferably 0.2 wt.-% to 2 wt.-% of the composition.

Dish wash compositions according to the invention, preferably both manual and automatic dish wash compositions, may comprise at least one non-ionic surfactant.

Examples of suitable non-ionic surfactants for dish wash compositions are already mentioned above for laundry compositions. The non-ionic surfactant generally improves the rinsing properties of automatic dish wash formulations.

Preferred non-ionic surfactants for automatic dish wash compositions are C8-C18 alkyl ethoxylates, and ether capped poly(oxyalkylated) alcohol surfactants, e.g., the ones that are discussed in U.S. Pat. No. 6,482,994 and WO 01/42408.

Examples of suitable non-ionic surfactants for dish wash compositions are already mentioned above for laundry compositions. The non-ionic surfactant generally improves the foam properties of manual dish wash formulations.

Preferred non-ionic surfactants for manual dish wash formulations are the condensation products of Guerbet alcohols with from 2 to 18 moles, preferably 2 to 15, more preferably 5-12 of ethylene oxide per mole of alcohol. Other preferred non-ionic surfactants for use herein include fatty alcohol polyglycol ethers, alkylpolyglucosides and fatty acid glucamides.

The manual hand dish detergent composition of the present invention may comprise from 0.1 wt.-% to 10 wt.-%, preferably from 0.3 wt.-% to 5 wt.-%, more preferably from 0.4 wt.-% to 2 wt.-% of the composition, of a linear or branched C10 alkoxylated non-ionic surfactant having an average degree of alkoxylation of from 2 to 6, preferably from 3 to 5. Preferably, the linear or branched C10 alkoxylated non-ionic surfactant is a branched C10 ethoxylated non-ionic surfactant having an average degree of ethoxylation of from 2 to 6, preferably of from 3 to 5. Preferably, the composition comprises from 60 wt.-% to 100 wt.-%, preferably from 80 wt.-% to 100 wt.-%, more preferably 100 wt.-% of the total linear or branched C10 alkoxylated non-ionic surfactant of the branched C10 ethoxylated non-ionic surfactant. The linear or branched C10 alkoxylated non-ionic surfactant preferably is a 2-propylheptyl ethoxylated non-ionic surfactant having an average degree of ethoxylation of from 3 to 5. A suitable 2-propylheptyl ethoxylated non-ionic surfactant having an average degree of ethoxylation of 4 is Lutensol® XP40, commercially available from BASF SE, Ludwigshafen, Germany. The use of a 2-propylheptyl ethoxylated non-ionic surfactant having an average degree of ethoxylation of from 3 to 5 leads to improved foam levels and long-lasting suds.

Thus, one aspect of the present invention is a manual dish wash detergent composition, in particular a liquid manual dish wash detergent composition, comprising (i) at least one inventive polymer, and (ii) at least one further 2-propylheptyl ethoxylated non-ionic surfactant having an average degree of ethoxylation of from 3 to 5.

In one embodiment of the present invention, the inventive polymer is one component of a dish wash formulation, preferably of an automatic dish wash formulation, that additionally comprises at least one builder, preferably at least one chelating agent.

Examples of suitable builders are already mentioned above for laundry compositions.

Preferred builders for dish wash compositions are selected from citrate, phosphates, silicates, carbonates, phosphonates, amino carboxylates and polycarboxylates. Even more preferred are builders selected from citrate, silicates, carbonates, phosphonates, amino carboxylates and polycarboxylates (i.e., phosphate-free compositions).

Particularly preferred is Na2CO3 and sodium citrate. Among the hydroxyalkanephosphonates, the 1-hydroxyethane-1,1-diphosphonate (HEDP) is of particular importance as builder. Preferred amino carboxylates are methylglycine diacetate (MGDA) and glutamine diacetate (GLDA). The term amino carboxylates and polycarboxylates also include their respective non-substituted or substituted ammonium salts and the alkali metal salts such as the sodium salts, in particular of the respective fully neutralized compound. Preferred polycarboxylates are for example polyaspartic acid or in particular alkali metal salts of (meth)acrylic acid homopolymers or (meth)acrylic acid copolymers. A suitable polymer is in particular polyacrylic acid, which preferably has a weight-average molecular weight Mw in the range from 2000 to 40 000 g/mol, preferably 2000 to 10 000 g/mol, in particular 3000 to 8000 g/mol.

Silicates in the context of the present invention include in particular sodium disilicate and sodium metasilicate, alumosilicates such as for example zeolites and sheet silicates, in particular those of the formula α-Na2Si2O5, β-Na2Si2O5, and δ-Na2Si2O5.

Compositions according to the invention can comprise, for example, in the range from in total 0.1 to 70% by weight, preferably 10 to 50% by weight, preferably up to 20% by weight, of builder(s), especially in the case of solid formulations. Liquid formulations according to the invention preferably comprise in the range of from 0.1 to 8% by weight of builder.

Dish wash compositions according to the invention, preferably automatic dish wash compositions, comprise one or more bleaching agents (bleaches).

Examples of suitable bleaching agents are already mentioned above for laundry compositions.

Preferred bleaching agent for dish wash compositions is sodium percarbonate, anhydrous or, for example, as the monohydrate.

In one embodiment of the present invention, the inventive polymer is one component of an automatic dish wash formulation that additionally comprises one or more bleach catalysts.

Examples of suitable bleach catalysts are already mentioned above for laundry compositions.

Dish wash compositions according to the invention, especially automatic dish wash compositions, comprise one or more bleach activators.

Examples of suitable bleach activators are already mentioned above for laundry compositions.

Preferred bleach activator for dish wash compositions is tetraacetyl ethylene diamine.

Dish wash formulations according to the invention may comprise one or more corrosion inhibitors. In the present case, this is to be understood as including those compounds which inhibit the corrosion of metal and/or glass. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol, pyrogallol or zinc salts, especially zinc benzoate, zinc gluconate, zinc lactate, zinc formicate, ZnCl2, ZnSO4, zinc acetate, zinc citrate, Zn(NO3)2, Zn(CH3SO3)2, zinc gallate, zinc oxide, zinc hydroxide and zinc carbonate.

In one embodiment of the present invention, the dish wash formulation according to the invention comprises additionally at least one enzyme.

Useful enzymes are, for example, one or more hydrolases selected from lipases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types, preferably at least one protease and one amylase.

Such enzyme(s) can be incorporated at levels sufficient to provide an effective amount for cleaning. The preferred amount is in the range from 0.001% to 5% of active enzyme by weight in the detergent composition according to the invention. Together with enzymes also enzyme stabilizing systems may be used such as for example calcium ions, boric acid, boronic acid, propylene glycol and short chain carboxylic acids. In the context of the present invention, short chain carboxylic acids are selected from monocarboxylic acids with 1 to 3 carbon atoms per molecule and from dicarboxylic acids with 2 to 6 carbon atoms per molecule. Preferred examples are formic acid, acetic acid, propionic acid, oxalic acid, succinic acid, HOOC(CH2)3COOH, adipic acid and mixtures from at least two of the foregoing, as well as the respective sodium and potassium salts.

Dish wash formulations according to the invention may comprise one or more alkali carriers. Alkali carriers ensure, for example, a pH of at least 9 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium. In one embodiment of the present invention, a pH>7 is adjusted by using amines, preferably alkanolamines, more preferably triethanolamine.

Dish wash compositions according to the invention may comprise at least one hydrotrope in an effective amount, to ensure the compatibility of the liquiddish wash detergent compositions with water.

Suitable hydrotropes for use herein include anionic hydrotropes, particularly sodium, potassium, and ammonium xylene sulfonate, sodium, potassium and ammonium toluene sulfonate, sodium, potassium, and ammonium cumene sulfonate, and mixtures thereof, and related compounds, as disclosed in U.S. Pat. No. 3,915,903.

The liquid dish wash detergent compositions of the present invention typically comprise from 0.1 wt.-% to 15 wt.-% of the total liquid detergent composition of a hydrotrope, or mixtures thereof, preferably from 1 wt.-% to 10 wt.-%, most preferably from 2 wt.-% to 5 wt.-% of the total liquid manual dish wash composition.

Dish wash compositions according to the invention may comprise at least one organic solvent.

Examples of organic solvents are C4-C14 ethers and diethers, glycols, alkoxylated glycols, C6-C16 glycol ethers, alkoxylated aromatic alcohols, aromatic alcohols, aliphatic branched alcohols, alkoxylated aliphatic branched alcohols, alkoxylated linear C1-C5 alcohols, linear C1-C5 alcohols, amines, C8-C14 alkyl and cycloalkyl hydrocarbons and halohydrocarbons, and mixtures thereof.

When present, the liquid dish wash compositions will contain from 0.01 wt.-% to 20 wt.-%, preferably from 0.5 wt.-% to 15 wt.-%, more preferably from 1 wt.-% to 10 wt.-%, most preferably from 1 wt.-% to 5 wt.-% of the liquid detergent composition of a solvent. These solvents may be used in conjunction with an aqueous liquid carrier, such as water, or they may be used without any aqueous liquid carrier being present. At higher solvent systems, the absolute values of the viscosity may drop but there is a local maximum point in the viscosity profile.

The dish wash compositions herein may further comprise from 30 wt.-% to 90 wt.-% of an aqueous liquid carrier, comprising water, in which the other essential and optional ingredients are dissolved, dispersed or suspended. More preferably the compositions of the present invention comprise from 45 wt.-% to 85 wt.-%, even more preferably from 60 wt.-% to 80 wt.-% of the aqueous liquid carrier. The aqueous liquid carrier, however, may contain other materials which are liquid, or which dissolve in the liquid carrier, at room temperature (25° C.) and which may also serve some other function besides that of an inert filler.

Dish wash compositions according to the invention may comprise at least one electrolyte.

Suitable electrolytes are preferably selected from inorganic salts, even more preferably selected from monovalent salts, most preferably sodium chloride.

The dish wash compositions according to the invention may comprise from 0.1 wt.-% to 5 wt.-%, preferably from 0.2 wt.-% to 2 wt.-% of the composition of an electrolyte.

Liquid dish wash formulations comprising the inventive polymer may also comprise at least one antimicrobial agent.

Examples of suitable antimicrobial agents for dish wash compositions are already mentioned above for laundry compositions.

The antimicrobial agent may be added to the inventive liquid dish wash composition in a concentration of 0.0001 wt.-% to 10 wt.-% relative to the total weight of composition. Preferably, the formulation contains 2-phenoxyethanol in a concentration of 0.01 wt.-% to 5 wt.-%, more preferably 0.1 wt.-% to 2 wt.-% and/or 4,4′-dichloro 2-hydroxydiphenyl ether in a concentration of 0.001 wt.-% to 1 wt.-%, more preferably 0.002 wt.-% to 0.6 wt.-% (in all cases relative to the total weight of the composition).

Further additional ingredients are such as but not limited to conditioning polymers, cleaning polymers, surface modifying polymers, soil flocculating polymers, rheology modifying polymers, enzymes, structurants, cyclic diamines, structurants, emollients, humectants, skin rejuvenating actives, carboxylic acids, scrubbing particles, perfumes, malodor control agents, pigments, dyes, opacifiers, beads, pearlescent particles, microcapsules, disintegrants, pH adjusters including NaOH and alkanolamines such as monoethanolamines and buffering means.

### (c) General Cleaning Compositions and Formulations

The liquid formulations disclosed in this chapter may comprise 0 to 2% 2-phenoxyethanol, preferably about 1%, in addition to all other mentioned ingredients.

The above and below disclosed liquid formulations may comprise 0-0.2% 4,4′-dichoro 2-hydroxydiphenylether, preferably about 0.15%, in addition to all other mentioned ingredients. The bleach-free solid laundry compositions may comprise 0-0.2% 4,4′-dichoro 2-hydroxydiphenylether, preferably about 0.15%, in addition to all other mentioned ingredients.

The formulations disclosed in this chapter may—in addition to all other mentioned ingredients—comprise one or more enzymes selected from those disclosed herein above, more preferably a protease and/or an amylase, wherein even more preferably the protease is a protease with at least 90% sequence identity to SEQ ID NO: 22 of EP1921147B1 and having the amino acid substitution R101 E (according to BPN′ numbering) and wherein the amylase is an amylase with at least 90% sequence identity to SEQ ID NO: 54 of WO2021032881A1, such enzyme(s) preferably being present in the formulations at levels from about 0.00001% to about 5%, preferably from about 0.00001% to about 2%, more preferably from about 0.0001% to about 1%, or even more preferably from about 0.001% to about 0.5% enzyme protein by weight of the composition.

The following compositions shown below including those in the tables disclose general cleaning compositions of certain types, which correspond to typical compositions correlating with typical washing conditions as typically employed in various regions and countries of the world. The at least one inventive polymer may be added to such formulation(s) in suitable amounts as outlined herein.

When the shown composition does not comprise an inventive polymer, such composition is a comparative composition. When it comprises an inventive polymer, especially in the amounts that are described herein as preferred, more preferred etc. ranges, such compositions are considered to fall within the scope of the present invention.

In a preferred embodiment the at least one PPI (as defined in any of the embodiments herein, especially the Embodiments 1 to 18; PPI in this section also named “inventive polymer”) is used in a laundry detergent.

Liquid laundry detergents according to the present invention are composed of:

| | |
|---|---|
| 0.05-20% | of at least one inventive polymer |
| 1-50% | of surfactants |
| 0.1-40% | of builders, cobuilders and/or chelating agents |
| 0.1-50% | other adjuncts |
| water | to add up 100%. |

Preferred liquid laundry detergents according to the present invention are composed of:

| | |
|---|---|
| 0.2-6% | of at least one inventive polymer |
| 5-40% | of anionic surfactants selected from C10-C15- LAS and |
| | C10-C18 alkyl ethersulfates containing 1-5 ethoxy-units |
| 1.5-10% | of nonioic surfactants selected from C10-C18-alkyl |
| | ethoxylates containing 3-10 ethoxy-units |
| 2-20% | of soluble organic builders/cobuilders selected from |
| | C10-C18 fatty acids, di- and tricarboxylic acids, hydroxy- |
| | di- and hydroxytricaboxylic acids and polycarboxylic acids |
| 0.05-5% | of an enzyme system containing at least one enzyme |
| | suitable for detergent use and preferably also an enzyme |
| | stabilizing system |
| 0.5-20% | of mono- or diols selected from ethanol, isopropanol, |
| | ethylenglycol, or propylenglyclol |
| 0.1-20% | other adjuncts |
| water | to add up to 100%. |

Solid laundry detergents (like e.g. powders, granules or tablets) according to the present invention are composed of:

| | |
|---|---|
| 0.05-20% | of at least one inventive polymer |
| 1-50% | of surfactants |
| 0.1-80% | of builders, cobuilders and/or chelating agents |
| 0-50% | fillers |
| 0-40% | bleach actives |
| 0.1-30% | other adjuncts and/or water wherein the sum |
| | of the ingredients adds up 100%. |

Preferred solid laundry detergents according to the present invention are composed of:

| | |
|---|---|
| 0.2-6% | of at least one inventive polymer |
| 5-30% | of anionic surfactants selected from C10-C15- LAS, |
| | C10-C18 alkylsulfates and C10-C18 alkyl ethersulfates |
| | containing 1-5 ethoxy-units |
| 1.5-7.5% | of non-ionic surfactants selected from C10-C18-alkyl |
| | ethoxylates containing 3-10 ethoxy-units |
| 5-50% | of inorganic builders selected from sodium carbonate, |
| | sodiumbicarbonate, zeolites, soluble silicates, sodium sulfate |
| 0.5-15% | of cobuilders selected from C10-C18 fatty acids, di- and |
| | tricarboxylic acids, hydroxydi- and hydroxytricarboxylic acids |
| | and polycarboxylic acids |
| 0.1-5% | of an enzyme system containing at least one enzyme |
| | suitable for detergent use and preferably also an enzyme |
| | stabilizing system |
| 0.5-20% | of mono- or diols selected from ethanol, isopropanol, |
| | ethylenglycol, or propylenglyclol |
| 0.1-20% | other adjuncts |
| water | to add up to 100% |

In a preferred embodiment the polymer according to the present invention is used in a manual dish wash detergent.

Liquid manual dish wash detergents according to the present invention are composed of:

| | |
|---|---|
| 0.05-10% | of at least one inventive polymer |
| 1-50% | of surfactants |
| 0.1-50% | of other adjuncts |
| water | to add up 100%. |

Preferred liquid manual dish wash detergents according to the present invention are composed of:

| | |
|---|---|
| 0.2-5% | of at least one inventive polymer |
| 5-40% | of anionic surfactants selected from C10-C15- LAS, |
| | C10-C18 alkyl ethersulfates |
| 2 10% | containing 1-5 ethoxy-units, and C10-C18 alkylsulfate |
| | of Cocamidopropylbetaine |
| 0-10% | of Lauramine oxide |
| 0-2% | of a non-ionic surfactant, preferably a C10-Guerbet |
| | alcohol alkoxylate |
| 0-5% | of an enzyme, preferably Amylase, and preferably |
| | also an enzyme stabilizing system |
| 0.5-20% | of mono- or diols selected from ethanol, isopropanol, |
| | ethylenglycol, or propylenglyclol |
| 0.1-20% | other adjuncts |
| water | to add up to 100% |

As the polypropylene imine polymers of the invention are biodegradable, and especially the cleaning formulations typically have a pH of about 7 or higher, and additionally often contain also enzymes—which are included into such cleaning formulations to degrade biodegradable stuff such as grease, proteins, polysaccharides etc. which are present in the stains and dirt which shall be removed by the cleaning compositions—some consideration is needed to be taken to formulate those bio-degradable polymers of the invention. Such formulations suitable are in principle known, and include the formulation in solids—where the enzymes and the polymers can be separated by coatings or adding them in separate particles which are mixed—and liquids and semi-liquids, where the polymers and the enzymes can be separated by formulating them in different compartments, such as different compartments of multi-chamber-pouches or bottles having different chambers, from which the liquids are poured out at the same time in a predefined amount to assure the application of the right amount per individual point of use of each component from each chamber. Such multi-compartment-pouches and bottles etc. are known to a person of skill as well.

The following table shows general cleaning compositions of certain types, which correspond to typical compositions correlating with typical washing conditions as typically employed in various regions and countries of the world. The at least one inventive polymer may be added to such formulation(s) in suitable amounts as outlined herein.

TABLE 1
General formula for laundry detergent
compositions according to the invention:

| | Ranges of Ingredient in |
|---|---|
| Ingredient | Liquid frame formulations |
| Linear alkyl benzene sulphonic acid | 0 to 30% |
| Coco fatty acid | 1 to 12% |
| Fatty alcohol ether sulphate | 0 to 25% |
| NaOH or mono or triethanol amine | Up to pH 7.5 to 9.0 |
| Alcohol ethoxylate | 3 to 10% |
| 1,2-Propylene glycol | 1 to 10% |
| Ethanol | 0 to 4% |
| Sodium citrate | 0 to 8% |
| water | Up to 100% |

TABLE 2
Liquid laundry frame formulations according to the invention:

| active | | | | | | | | |
|---|---|---|---|---|---|---|---|---|
| (numbers: % active) | F1 | F2 | F3 | F4 | F5 | F6 | | |
| alcohol ethoxylat 7EO | 5.40 | 10.80 | 12.40 | 7.30 | 1.60 | 7.60 | | |
| Coco fatty acid K12-18 | 2.40 | 3.10 | 3.20 | 3.20 | 3.50 | 6.40 | | |
| Fatty alcohol ether sulphate | 5.40 | 8.80 | 7.10 | 7.10 | 5.40 | 14.00 | | |
| Linear alkyl benzene sulphonic | 5.50 | 0.00 | 14.50 | 15.50 | 10.70 | 0.00 | | |
| acid | | | | | | | | |
| 1,2 Propandiol | 6.00 | 3.50 | 8.70 | 8.70 | 1.10 | 7.80 | | |
| Triethanolamine | | | | | | | | |
| Monoethanolamine | | | 4.00 | 4.30 | 0.30 | | | |
| NaOH | 2.20 | 1.10 | | | | 1.00 | | |
| Glycerol | | 0.80 | 3.00 | 2.80 | | | | |
| Ethanol | 2.00 | | | | 0.38 | 0.39 | | |
| Na citrate | 3.00 | 2.80 | 3.40 | 2.10 | 7.40 | 5.40 | | |
| Inventive Polymer (s) (total) * | 0-5 | 0-5 | 0-5 | 0-5 | 0-5 | 0-5 | | |
| Protease | 0-1 | 0-1 | 0-1 | 0-1 | 0-1 | 0-1 | | |
| Amylase | 0-0.5 | 0-0.5 | 0-0.5 | 0-0.5 | 0-0.5 | 0-0.5 | | |
| Cellulase | 0-0.3 | 0-0.3 | 0-0.3 | 0-0.3 | 0-0.3 | 0-0.3 | | |
| Lipase | 0-0.2 | 0-0.2 | 0-0.2 | 0-0.2 | 0-0.2 | 0-0.2 | | |
| Mannanase | 0-0.2 | 0-0.2 | 0-0.2 | 0-0.2 | 0-0.2 | 0-0.2 | | |
| Pectat Lyase | 0-0.3 | 0-0.3 | 0-0.3 | 0-0.3 | 0-0.3 | 0-0.3 | | |
| water | to 100 | to 100 | to 100 | to 100 | to 100 | to 100 | | |
| active | | | | | | | | |
| (numbers: % active) | F7 | F8 | F9 | F10 | F11 | F12 | F13 | F14 |
| alcohol ethoxylat 7EO | 3.80 | 0.30 | 13.30 | 8.00 | 5.70 | 20.00 | 9.20 | 29.00 |
| Coco fatty acid K12-18 | 2.80 | 3.00 | 1.70 | 1.80 | 2.50 | 5.00 | 8.60 | 10.40 |
| Fatty alcohol ether sulphate | 2.80 | 4.50 | 3.90 | 4.10 | | 10.00 | 22.20 | |
| Linear alkyl benzene | 6.30 | 5.43 | 11.45 | 5.90 | 10.10 | 10.00 | 28.00 | 27.00 |
| sulphonic acid | | | | | | | | |
| 1,2 Propandiol | 0.50 | | 2.50 | 0.40 | 6.00 | 10.00 | 7.00 | 7.00 |
| Triethanolamine | | | | 8.10 | | | | |
| Monoethanolamine | 0.40 | 1.80 | | | | | 8.00 | 7.00 |
| NaOH | | | 2.20 | | 3.30 | 1.50 | | |
| Glycerol | | 0.60 | 0.20 | 1.90 | | | 7.00 | 10.00 |
| Ethanol | | | 1.84 | | | | | |
| Na citrate | 4.60 | 3.30 | 3.30 | 1.40 | | 1.50 | | |
| Inventive Polymer (s) | 0-5 | 0-5 | 0-5 | 0-5 | 0-5 | 0-5 | 0-5 | 0-5 |
| (total)* | | | | | | | | |
| Protease | 0-1 | 0-1 | 0-1 | 0-1 | 0-1 | 0-3 | 0-3 | 0-3 |
| Amylase | 0-0.5 | 0-0.5 | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 | 0-0.3 | 0-0.3 |
| water | to 100 | to 100 | to 100 | to 100 | to 100 | to 100 | to 100 | to 100 |

*Without inventive polymer the formulations are comparative examples.

TABLE 3
Laundry powder frame formulations according to the invention:

| | Bleach free Powder | | | | | |
|---|---|---|---|---|---|---|
| Alcohol ethoxylate 7EO | 0.6 | 0 | 1 | 0 | 0 | 5.2 |
| Coco fatty acid K12-18 | 1.2 | 0 | 0 | 0 | 0 | 0 |
| Fatty alcohol ether sulphate | 1.5 | 0 | 0 | 0 | 0 | 6 |
| Linear alkyl benzene sulphonic | 12.1 | 11.2 | 13.6 | 21.9 | 18.7 | 12.7 |
| acid | | | | | | |
| Bleach activator | 0 | 0 | 0 | 0 | 0 | 0 |
| Percarbonate | 0 | 0 | 0 | 0 | 0 | 0 |
| AcetateNa | 0 | 0 | 0 | 0.1 | 0 | 0.1 |
| CitrateNa | 0 | 0 | 0 | 0 | 0 | 14 |
| Na Silicate | 27.9 | 5.8 | 6.6 | 2 | 15 | 20.3 |
| Na Carbonate | 17.2 | 35 | 37.3 | 30.1 | 37 | 1 |
| Na Phospahte | 0 | 0 | 0 | 14 | 0.3 | 0 |
| Na Hydrogencarbonate | 0.7 | 0.9 | 0.5 | 2.7 | 0.4 | 10.5 |
| Zeolite4A | 4.2 | 0.1 | 5.1 | 10.2 | 1.8 | 11.6 |
| HEDP | 0 | 0 | 0 | 0 | 0 | 0.13 |
| MGDA | 0 | 1.1 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 30.8 | 1.3 | 33 | 11 | 22 | 3 |
| Na Chloride | 0.2 | 43 | 0.1 | 0 | 0.1 | 0.1 |
| optical brightener | 0.02 | 0 | | 0.1 | 0.06 | |
| Inventive Polymer(s) (total) | 1 | 1 | 0.2 | 2 | 0.5 | 3 |
| | Bleach containing Powder | | | | | |
| Alcohol ethoxylate 7EO | 1.2 | 5 | 4 | 0.5 | 0.5 | 0 |
| Coco fatty acid K12-18 | 0 | 0 | 0 | 0.3 | 0 | 0.6 |
| Fatty alcohol ether sulphate | 0 | 3.9 | 4.4 | 1.6 | 0 | 0 |
| Linear alkyl benzene sulphonic | 7.6 | 12.1 | 11.5 | 12.2 | 6.5 | 10.4 |
| acid | | | | | | |
| Bleach activator | 0.2 | 9.5 | 9.5 | 0.5 | 0.8 | 2.2 |
| Percarbonate | 3.6 | 19.4 | 16.6 | 2.2 | 11.5 | 5.8 |
| AcetateNa | 0 | 6.7 | 7.1 | 0.3 | 1 | 0.7 |
| CitrateNa | 0 | 1.6 | 8.2 | 0.3 | 0.9 | 1.7 |
| Na Silicate | 3.6 | 11.3 | 16.4 | 10.2 | 9.1 | 16.5 |
| Na Carbonate | 21.6 | 8.7 | 1.4 | 8 | 22.9 | 14.8 |
| Na Phospahte | 0 | 0 | 0 | 0 | 0 | 0 |
| Na Hydrogencarbonate | 0.2 | 2.8 | 1.6 | 0.8 | 0.5 | 0.5 |
| Zeolite4A | 1.6 | 1.4 | 2.4 | 1.6 | 1.8 | 2.3 |
| HEDP | 0 | 0.27 | 0.16 | 0 | 0 | 0.17 |
| MGDA | 0 | 0 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 51 | 4 | 6 | 57 | 38 | 37 |
| Na Chloride | 1 | 1 | 0.5 | 1.2 | 0.2 | 1 |
| optical brightener | | 0.29 | 0.1 | 0.23 | 0.13 | 0.19 |
| Inventive Polymer(s) (total) | 2.2 | 9.2 | 2.2 | 0.7 | 1 | 0.4 |

TABLE 4
Liquid manual dish wash frame formulations according to the invention:

| Ingredients | MDW.1 | MDW.2 | MDW.3 | MDW.4 | MDW.5 | MDW.6 | MDW.7 | MDW.8 |
|---|---|---|---|---|---|---|---|---|
| Linear C₁₂-C₁₄-alkyl- | 8 | 0 | 6 | 0 | 6 | 0 | 6 | 0 |
| benzenesulfonic acid | | | | | | | | |
| C₁₂-C₁₄-fatty alcohol × | 8 | 16 | 6 | 12 | 6 | 12 | 6 | 12 |
| 2 EO sulfate | | | | | | | | |
| Cocamidopropyl betaine | 0 | 0 | 4 | 4 | 0 | 0 | 2 | 2 |
| Lauramine oxide | 0 | 0 | 0 | 0 | 4 | 4 | 2 | 2 |
| 2-Propylheptanol × 4 | 0.5 | 0.5 | 0.5 | 0.5 | 0.5 | 0.5 | 0.5 | 0.5 |
| EO | | | | | | | | |
| Inventive | 1 | 1 | 1 | 1 | 1 | 1 | 1 | 1 |
| Polymer (s) (total) | | | | | | | | |
| Ethanol | 2 | 2 | 2 | 2 | 2 | 2 | 2 | 2 |
| 2-Phenoxyethanol | 1 | 1 | 1 | 1 | 1 | 1 | 1 | 1 |
| (preservative) | | | | | | | | |
| Sodium chloride | 1 | 1 | 1 | 1 | 1 | 1 | 1 | 1 |
| Demin. water | add 100 | add 100 | add 100 | add 100 | add 100 | add 100 | add 100 | add 100 |
| Sodium hydroxide | add | add | add | add | add | add | add | add |
| | pH 8 | pH 8 | pH 8 | pH 8 | pH 8 | pH 8 | pH 8 | pH 8 |

The following examples shall further illustrate the present invention without restricting the scope of the invention.

The specific embodiments as described throughout this disclosure are encompassed by the present invention as part of this invention; the various further options being disclosed in this present specification as “optional”, “preferred”, “more preferred”, “even more preferred” or “most preferred” (or “preferably” etc.) options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently unless such independent selection is not possible by virtue of the nature of that feature or if such independent selection is explicitly excluded), with each and any and all such possible combinations being included as part of this invention as individual embodiments.

### EXAMPLES

### 1) Synthesis Examples

General remark: In all the examples, step b) is begun after step a) is ended and step c) is begun after step b) is ended (conversion of monomers>95%).

### a) Synthesis of Compounds According to the Present Invention

### i) Synthesis of (unmodified) PPI

“N,N′-Bis-(3-aminopropyl)-ethylene diamine” is abbreviated as “N4-Amine” or “N4”, “1,3-propylene diamine” is abbreviated as “1,3-PDA” orjust “PDA” and “hexamethylene diamine” is abbreviated as “HMDA” in the following.

### Example 1: Synthesis of PPI Homopolymer (Poly(PDA)) with Mn=230 g/Mol, Mw=380 g/Mol (A.1)

In a tubular reactor with an inner diameter of 10 mm equipped with an inner thermowell of 3.17 mm, 1,3-PDA was continuously led, together with 15 NI/h hydrogen gas, over a fixed bed catalyst consisting of Co as the active metal. The pressure was 50 bar, the temperature 164° C. 1,3-PDA was fed into the reactor with 0.68 kg/Lcat*h. The desired product was obtained as a water white liquid after removal of monomers in vacuo for 1 hour (10 mbar @80° C.).

### Example 2: Synthesis of PPI Copolymer (Poly(PDA-Co-N4)) with Mn=280 g/Mol, Mw=520 g/Mol (A.2)

In a tubular reactor with an inner diameter of 10 mm equipped with an inner thermowell of 3.17 mm, 1,3-PDA and N4-Amine in a ratio of 3:1 wt % was continuously led, together with 15 NI/h hydrogen gas, over a fixed bed catalyst consisting of Co as the active metal. The pressure was 50 bar, the temperature 160° C. The mixture of 1,3-PDA and N4-Amine was fed into the reactor with 0.32 kg/Lcat*h. The desired product was obtained as a water white liquid after removal of monomers in vacuo for 1 hour (10 mbar @80° C.).

### Example 3: Synthesis of PPI Copolymer (Poly(PDA-Co-HMDA)) with Mn=340 g/Mol, Mw=690 g/Mol (A.3)

In a tubular reactor with an inner diameter of 10 mm equipped with an inner thermowell of 3.17 mm, 1,3-PDA and HMDA in a ratio of 3:1 wt % was continuously led, together with 15 NI/h hydrogen gas, over a fixed bed catalyst consisting of Co as the active metal. The pressure was 50 bar, the temperature 163° C. The mixture of 1,3-PDA and HMDA was fed into the reactor with 0.44 kg/Lcat*h. The desired product was directly obtained as a water white liquid without any purification step in between.

### ii) Synthesis of Modified PPI

### Example 1: Synthesis of Poly(PDA-co-N4)) (Mw 520 g/mol; A.2)+2 CL/NH+24 EO/NH+16 PO/NH (P.1)

### Example 1a: Poly(PDA-Co-N4)) (Mw 520 g/Mol; A.2)+2 CL/NH

80 g of the previously obtained product are charged into a four-necked round bottom flask equipped with a cooler and a dripping funnel under nitrogen atmosphere. The product is heated to 80° C. and 463 g of caprolactone are added slowly at 80° C. After caprolactone addition, the temperature is increased slowly to 160° C. and the mixture is allowed to post-react sixteen hours at 160° C. to remove any residual caprolactone. 492 g of a light brown, highly viscous liquid were obtained.

### Example 1b: Poly(PDA-Co-N4)) (Mw 520 g/Mol; A.2)+2 CL/NH+24 EO/NH

100 g of the previously obtained product (example 1a) are filled into a steel pressure reactor and 1.3 g of potassium methanolate (32.5 wt % in methanol) are added. Methanol is removed at 20 mbar at 80° C. The reactor is purged with nitrogen to remove air and a nitrogen pressure of 2 bar is set. The reactor is heated to 130° C. and 287 g of ethylene oxide are dosed into the reactor within four hours. The mixture is allowed to post-react for six hours at 130° C. to remove any residual ethylene oxide.

### Example 1c: Poly(PDA-Co-N4)) (Mw 520 g/Mol; A.2)+2 CL/NH+24 EO/NH+16 PO/NH (P.1)

To the previously obtained product (example 1b) in the reactor are dosed 252 g of propylene oxide within five hours. The mixture is allowed to post-react for 6 hours at 130° C. to remove any residual propylene oxide. Finally, 652 g of an orange, highly viscous liquid were obtained as product P.1.

### b) Comparative Examples

### i) Synthesis of Polypropylene Imines

### Comparative Example 1: Synthesis of Polypropylene Imine Homopolymer (Poly(PDA)) with Mn=570 g/Mol, Mw=1400 g/Mol (CA.1)

In a tubular reactor with an inner diameter of 10 mm equipped with an inner thermowell of 3.17 mm, 1,3-PDA was continuously led, together with 15 NI/h hydrogen gas, over a fixed bed catalyst consisting of Co as the active metal. The pressure was 50 bar, the temperature 170° C. 1,3-PDA was fed into the reactor with 0.29 kg/Lcat*h. The desired product was directly obtained as a white solid without any purification step in between.

### Comparative Example 2: Synthesis of Polypropylene Imine Copolymer (Poly(PDA-Co-N4)) with Mn=410 g/Mol, Mw=820 g/Mol (CA.2)

In a tubular reactor with an inner diameter of 10 mm equipped with an inner thermowell of 3.17 mm, 1,3-PDA and N4-Amine in a ratio of 3:1 wt % was continuously led, together with 15 NI/h hydrogen gas, over a fixed bed catalyst consisting of Co as the active metal. The pressure was 50 bar, the temperature 167° C. 1,3-PDA was fed into the reactor with 0.3 kg/Lcat*h. The desired product was directly obtained as a high viscous material without any purification step in between.

### Comparative Example 3: PEI 600 (CA.3)

PEI 600 was commercially obtained as Lugalvan® FG from BASF SE, Ludwigshafen, Germany

### ii) Synthesis of Modified PPI and Comparative Examples

### Comparative Example 1: Synthesis of PEI 600+2 CL+23 EO/NH+15 PO/NH (CP.1)

### Example 1a: PEI 600+2 CL/NH

280 g of polyethylene imine with Mw=600 g/mol are charged into a four-necked round bottom flask equipped with a cooler and a dripping funnel under nitrogen atmosphere. The product is heated to 80° C. and 1499 g of caprolactone are added slowly at 80° C. After caprolactone addition, the temperature is increased slowly to 160° C. and the mixture is allowed to post-react sixteen hours at 160° C. to remove any residual caprolactone. 1725 g of an orange, highly viscous liquid were obtained.

### Example 1b: PEI 600+2 CL/NH+23 EO/NH

100 g of the previously obtained product (example 1a) are filled into a steel pressure reactor and 4.8 g of potassium methanolate (32.5 wt % in methanol) are added. Methanol is removed at 20 mbar at 80° C. The reactor is purged with nitrogen to remove air and a nitrogen pressure of 2 bar is set. The reactor is heated to 130° C. and 360 g of ethylene oxide are dosed into the reactor within six hours. The mixture is allowed to post-react for three hours at 130° C. to remove any residual ethylene oxide.

### Example 1c: PEI 600+2 CL/NH+23 EO/NH+15 PO/NH

To the previously obtained product (example 1b) in the reactor are dosed 317 g of propylene oxide within six hours. The mixture is allowed to post-react for five hours at 130° C. to remove any residual propylene oxide. Finally, 767 g of a dark red liquid were obtained as product CP.1.

### Comparative Example 2: PEI 600, Ethoxylated and Propoxylated (24 EO-16 PO) (CP.2)

This example is prepared as described in WO 95/32272 by a two-step alkoxylation.

### 2) Characterization of Polymers

Molecular weights of the (unmodified) PPI and comparative polymers were determined by gel permeation chromatography (GPC). The measurements were carried out on a column combination of three following columns: HFIP-LG Guard, PL HFIPGEL and PL HFIPGel. Elution was performed at a constant flow rate of 1 mL/min with Hexafluoroisopropanol and 0.05 wt % Potassium trifluroroacetate. The injected sample was prefiltered over a Millipore Millex FG (0.2 μm), 50 μL were injected with a concentration of 1.5 mg/mL (diluted in eluent). The effluent was monitored by the UV detector DRI Agilent 1100 at A=230 and 280 nm. The calibration was carried out using PMMA standards (PSS, Mainz, Germany) with a molecular weight from 800 to 2 200 000 g/mol. Values outside of the calibration range were extrapolated.

Molecular weights of the modified alkoxylated polyalkylene imines may be determined by gel permeation chromatography (GPC). The measurements may be carried on a combination of two columns (styrene-divinylbenzene and polyester copolymer, both 25 cm in length), using 0.05 wt % Potassium trifluoroacetate in Hexafluoroisopropanol as eluent. The molecular weights may be obtained by using an RI detector and PEO standards (Polymer Laboratories/Agilent, USA) for calibration. In addition, the absolute molar mass may be determined by multi angle light scattering (MALLS).

Molecular weights of the modified PPI and modified comparative polymers were obtained by theoretical calculations, using the determined weight-average molecular weights of the polyamine starting materials and assuming complete conversion during the modification step (b). The calculations were performed as follows:

In case of copolymer backbones, first the molar ratio of the monomers in the polymer backbone has been calculated, based on the wt % composition of the materials. Subsequently, the average number of monomer-repeating units in the backbone has been calculated, based on the weight-average molecular weights of the polyamine starting materials (from GPC data, see above), the known molecular weights of the employed monomers and their molar ratio. Based on the known structural information of the employed monomers and their individual number of NH-functional groups, the total number of NH-functional groups of the polyamine starting materials has been obtained accordingly, which represent the sum of the NH-functional groups of all primary and secondary amino groups in the polymer backbone. In the second step, the average theoretical molecular weight of one attached linear chain has been calculated, using the employed molar amount of hydroxy carbon acid, EO and PO per NH-functional group and assuming complete conversion during all individual modification reactions within step (b). In the third step, the overall molecular weight of the inventive modified polypropylene imine homo- and copolymers and the comparative polymers, respectively, has been calculated, by (i) multiplication of the number of NH-functional groups of the polyamine backbone and the average molecular weight of one attached linear chain—assuming that on average one linear chain has been attached to one available NH-functional group of the backbone in case of a first alkoxylation reaction within step (b); and assuming that on average one linear chain has been attached to one primary NH2-functional group of the backbone and to one secondary NH-functional group in case of a first amidation reaction within step (b)—and (ii) adding the molecular weight of the polyamine backbone (from GPC data, see above) itself.

Composition and analytical data of the inventive modified PPI and comparative polymers are summarized in Table 1.

“CL/NH” means caprolactone (CL) repeating units per NH group of the core amine, “EO/NH” means ethylene oxide (EO) repeating units per NH group of the core amine, “PO/NH” means propylene oxide (PO) repeating units per NH group of the core amine. Caprolactone, EO and PO units are attached to form block structures, with caprolactone units being directly linked to the polyamine core.

TABLE 1
Composition and physicochemical characterization of inventive
modified polypropylene imine homo-/copolymers and comparative polymers.

| | | | Molecular | | | | Molecular |
|---|---|---|---|---|---|---|---|
| | | Monomer | weight | | | | weight |
| | | ratio | M_{w} | | | | (Modified |
| Modified | Amine starting | (Amine) | (Amine) | CL/ | EO/ | PO/ | Polymer) |
| Polymer | material | [wt %] | [g/mol] | NH | NH | NH | [g/mol] |
| P.1 | Poly(PDA-co- | PDA:N4 | 520 | 2 | 24 | 16 | 25800 |
| | N4) Copolymer | 75:25 | | | | | |
| | (A.2) | | | | | | |
| CP.1 | PEI (CA.3) * | — | 600 | 2 | 23 | 15 | 35200 |
| CP.2 | PEI (CA.3) * | — | 600 | — | 24 | 16 | 33100 |

* Lugalvan ® FG, commercially available from BASF SE, Ludwigshafen, Germany.

### 3) Application Experiments

### Primary Cleaning Performance on Oily/Fatty Stains

To determine the primary detergency, the cleaning performance on 16 different oily/fatty stains on cotton, polycotton and polyester fabrics (CFT, Vlaardingen, The Netherlands) was measured by determining the color difference (delta E) between the stains after wash and the unsoiled white fabric using a reflectometer (Datacolor SF600 plus). Each experiment containing the 16 different circular oily/fatty stains (Lipstick, Make-Up, Beef Fat, Frying Fat, Burnt Butter, Palm Oil, Sebum BEY, Sebum Tefo, Collar Stain; All on different fabrics) was repeated 6 times, and the obtained data was used to calculate the average delta E value.

By using these delta E values, the so-called “standardized cleaning performance” (delta delta E) has been calculated for each individual stain. The “standardized cleaning performance” (delta delta E) is the difference of the performance of the laundry detergent including the modified polyalkylene imine (inventive or comparative, respectively) vs. the laundry detergent w/o any modified polyalkylene imine (inventive or comparative, respectively).

Table 2 shows the composition of the laundry detergent, Table 3 shows the washing test conditions and Table 4 summarizes the obtained standardized cleaning performance. The standardized cleaning performance shown in Table 4 is the sum of the standardized cleaning performance of all 16 stains. The bigger the sum of the delta delta E value, the bigger the positive contribution of the modified polyalkylene imine (inventive or comparative, respectively), on the cleaning performance.

TABLE 2
Composition of the liquid laundry detergent.

| Ingredients | LLD.1 * |
|---|---|
| Linear C₁₂C₁₄-alkylbenzenesulfonic acid | 5.50 |
| C₁₂-fatty alcohol × 2 EO sulfate | 5.40 |
| C₁₂C₁₅-fatty alcohol × 7 EO | 5.40 |
| Coconut C12-C18 fatty acid | 2.40 |
| Sodium hydroxide | 2.20 |
| 1,2-Propylene glycol | 6.00 |
| Ethanol | 2.00 |
| Sodium citrate | 3.00 |
| Demin. water | add 100 |
| pH value | 8.5 |

* All data are wt % active ingredient, independent of the respective product form.

TABLE 3
Washing conditions for evaluation of primary
cleaning performance on oily/fatty stains.
Washing conditions

| Device | Launder-O-Meter from SDL Atlas, Rock Hill, USA | |
|---|---|---|
| Washing liquor | 250 | mL |
| Washing time | 60 | minutes |
| Washing temperature | 30° | C. |
| Detergent concentration | 3.0 | g/L |

| | |
|---|---|
| Water hardness (Ca:Mg:HCO3) | 2.5 mmol/L (4:1:8) (14° dH) |
| Fabric to liquor ratio | 1:10 |
| Modified polyalkylene imine | 2.83% by weight (vs. liquid laundry detergent) of |
| (inventive or comparative) | the polymer, 100% active ingredient |
| Test fabric * | 16 different circular oily/fatty stains (KC-H122, |
| | KC-H176, KC-H015, KC-H187, PC-H082, |
| | PC-H212, PC-H210, PC-H252, P-H122, |
| | P-H129, P-H015, P-H187, P-H082, P-H212, |
| | P-H210, P-H252) (CFT, Vlaardingen, |
| | The Netherlands) |
| Ballast fabric | Polyester and cotton ballast, to yield a 1:1 ratio |
| | of polyester/cotton fabric per experiment |

* After the washing experiment, the test fabrics were rinsed with 14° dH water (2 times), followed by drying at ambient room temperature overnight, prior to the measurement with the reflectometer.

TABLE 4
Results from washing tests (primary
cleaning performance on oily/fatty stains).

| | | Concentration | Standardized |
|---|---|---|---|
| | | of | cleaning |
| | | polymeric | performance |
| Detergent | Polymer | additive * | (sum delta delta E) |
| LLD.1 | P.1 | 2.83 wt % | 26.5 |
| LLD.1 | CP.1 | 2.83 wt % | 34.2 |
| LLD.1 | CP.2 | 2.83 wt % | 79.9 |

* All data are wt % active ingredient, independent of the respective product form.

### Test Results

The error of the measurement is +/−10 delta delta E units. Therefore, any value>10 (sum delta delta E) means that the respective polymer exhibits a directional and visible contribution to the overall cleaning performance of the respective detergent formulation; Any value>20 (sum delta delta E) means that the respective polymer exhibits even a significant contribution to the overall cleaning performance, i.e., the respective polymer leads to a significant improvement of the formulation. All polymers (inventive and comparative) exhibit significant cleaning benefits on oily/fatty stains.

### 4) Biodegradation Data

Biodegradation in wastewater was tested in triplicate using the OECD 301 F manometric respirometry method. OECD 301 F is an aerobic test that measures biodegradation of a sample by measuring the consumption of oxygen. To a measured volume of medium, 100 mg/L test substance, which is the nominal sole source of carbon is added along with the inoculum (30 mg/L, aerated sludge taken from Mannheim wastewater treatment plant). This is stirred in a closed flask at a constant temperature (20° C. or 25° C.) for 28 or 56 days, respectively. The consumption of oxygen is determined by measuring the change in pressure in the apparatus using an OxiTop® C (Xylem 35 Analytics Germany Sales GmbH & Co KG). Evolved carbon dioxide is absorbed in a solution of sodium hydroxide. Nitrification inhibitors are added to the flask to prevent usage of oxygen due to nitrification. The amount of oxygen taken up by the microbial population during biodegradation of the test substance (corrected for uptake by blank inoculum, run in parallel) is expressed as a percentage of ThOD (Theoritical oxygen demand, which is measured by the elemental analysis of the compound). A positive control Glucose/Glucosamine is run along with the test samples for each cabinet.

TABLE 5
Biodegradability tests

| | Biodeg data after | | Biodeg data after | |
|---|---|---|---|---|
| Example | 28 days ¹⁾ | | 56 days ²⁾ | |
| A.1 | +++ | (64%) | +++ | (>60%) |
| A.2 | ++ | (39%) | ++ | (59%) |
| A.3 | ++ | (20%) | ++ | (41%) |
| CA.1 | o | (0%) | o | (n.d.) |
| CA.2 | + | (16%) | + | (37%) |
| CA.3 | o | (<10%) | o | (<10%) |

| | | | |
|---|---|---|---|
| P.1 | +++ | (49%) | n.d. |
| CP.1 | +++ | (46%) | n.d. |
| CP.2 | o | (<10%) | n.d. |

¹⁾ Biodegradation according to the OECD 301F test after 28 days: o = <10%/+ = 10-19%/++= 20-40%/+++ = >40%
²⁾ Biodegradation according to the OECD 301F test after 56 days: o = <10%/+ = 10-39%/++ = 40-60%/+++ = >60%

### Comments on the Biodegradation-Test Results:

Only the inventive polyamine materials (A.1-A.3) exhibit good biodegradation properties (>20% after 28 days, >40% after 56 days) in the OECD 301 F test. It can be also clearly seen that polyamine A.2 exhibits a significantly better biodegradability than polyamine CA.2 with identical molecular composition and architecture, but significantly lower molecular weight. Therefore, only the inventive modified material P.1 (based on polyamine A.2) shows a good combination of cleaning performance (i.e., visible improvement of the formulation) and biodegradation of both the starting material and the final product. Compared to P.1, polymer CP.1 also shows good cleaning performance and biodegradation of the final product, however, the polyamine CA.3 that forms the core of polymer CP.1 must be considered as non-biodegradable or at least persistent (see also Table 6 below).

### 5) Melting Point of Amine Starting Materials

The melting point of the amine starting materials was measured with a TA Instruments Q2000 device, following DIN EN 11357-3.

TABLE 6
Melting points of polyamines (starting materials).

| | Monomer | Molecular | |
|---|---|---|---|
| Amine | ratio | weight M_{w} | Melting |
| starting | (Amine) | (Amine) | Point |
| material | [wt %] | [g/mol] | [° C.] |
| A.1 | PDA 100 | 380 | 8.9 |
| A.2 | PDA:N4 75:25 | 520 | −1.8 |
| A.3 | PDA:HMDA 75:25 | 690 | 13.5 |
| CA.1 | PDA 100 | 1400 | 44.4 |
| CA.2 | PDA:N4 75:25 | 820 | 26.3 |

The analytical data demonstrate that the polyamine backbones of the inventive polymers (A.1-A.3) have significantly lower melting points than the polyamine backbones of the comparative polymers (CA.1 and CA.2), due to their lower molecular weight and predominantly linear architecture, and independent of their composition (homopolymers/copolymers). Due to their lower melting points, they are much easier to produce.

### 6) Summary of all Examples

TABLE 7
Summary of data for inventive and comparative modified polyalkylene imines.

| | Biodegradation | Bio- | Biodegradation | | Application |
|---|---|---|---|---|---|
| | Polyamine | degradation | modified | Pro- | Perfor- |
| Polymer | core ²⁾ | Shell ^{1) 3)} | Polyamine ¹⁾ | ducibility ⁴⁾ | mance ⁵⁾ |
| P.1 | ++ | +++ | +++ | +++ | ++ |
| CP.1 | o | +++ | +++ | +++ | ++ |
| CP.2 | o | +++ | o | +++ | +++ |

¹⁾ Biodegradation according to the OECD 301F test after 28 days; see above
²⁾ Biodegradation according to the OECD 301F test after 56 days; see above
³⁾ determined separately by synthesizing the linear chains and evaluation of their biodegradability in the OECD 301F test
⁴⁾ Melting point of PPI: o = >25° C./+ = <25° C./++ = <20° C./+++ = <15° C., or +++ = PEI (easier synthesis process vs. PPI: Ring-opening polymerization of aziridine, thus clogging of heterogeneous catalyst tubes cannot occur)
⁵⁾ Primary cleaning performance on oily/fatty stains o = <10 sum delta delta E/+ = 10-24 sum delta delta E/++ = 25-40 sum delta delta E/+++ = >40 sum delta delta E

### Test Results

The experimental examples show that only the inventive polymer P.1 exhibits very good biodegradation properties, both for the final macromolecule and alongside the synthesis process (all starting materials and hydrolyzed fragments). In addition, P.1 exhibits significant cleaning benefits for primary cleaning of oily/fatty stains like non-degradable or partially degradable comparative polymers CP.1 and CP.2. Furthermore, the inventive polymer P.1 is based on an inventive polyamine backbone A.2 that exhibits a significantly lower melting point compared to other polypropylene imines with higher molecular weight, especially compared to polypropylene imine homopolymers with high molecular weight, thus enabling a better handling in the production process. The inventive polymers are therefore ideally suitable for preparation of fully biodegradable multi-benefit detergent formulations, and specifically for improved oily soil removal in laundry care and improved degreasing properties in manual dishwashing.

### 7) Formulations Comprising Inventive Polymers and Biocides

Inventive and comparative liquid laundry detergent formulations are prepared with or without (comparative) 2.8% by weight of the inventive polymer P.1 (100% active ingredient) and either 0.2% of the biocide Tinosan® HP 100 (from BASF SE) or 1% 2-phenoxyethanol (Protectol® PE, BASF SE). The formulations are prepared by first preparing a premix, containing the AEO und AES surfactants, the solvents 1,2-propanediol and ethanol and, where relevant, Tinosan® HP 100 or 2-phenoxyethanol. This premix is stirred at room temperature to a homogeneous mixture. Then, LAS, fatty acid and citric acid, as shown in Table 7, and water up to 90% are added. Subsequently, the pH is set to pH=8.5 using NaOH. Then the final formulations are prepared by stirring at room temperature: 90% of this obtained mixture, the appropriate concentrations of the present polymer and water up 100%.

Compositions and results are shown in Table 8.

TABLE 8

| | Formulation A | Formulation B | Formulation C | Formulation D |
|---|---|---|---|---|
| Ingredient | (comparative) | (comparative) | (inventive) | (inventive) |
| AEO | 5.4% | 5.4% | 5.4% | 5.4% |
| AES | 7.7% | 7.7% | 7.7% | 7.7% |
| LAS | 5.5% | 5.5% | 5.5% | 5.5% |
| Coco-fatty acid | 2.4% | 2.4% | 2.4% | 2.4% |
| citric acid | 3% | 3% | 3% | 3% |
| 1,2-propanediol | 6% | 6% | 6% | 6% |
| ethanol | 2% | 2% | 2% | 2% |
| Polymer P.1 | — | — | 2.8% | 2.8% |
| Tinosan ® HP | 0.2% | | 0.2% | |
| 100 | | | | |
| 2- | — | 1% | | 1% |
| Phenoxyethanol | | | | |
| NaOH | Up to pH = 8.5 | Up to pH = 8.5 | Up to pH = 8.5 | Up to pH = 8.5 |
| Water | Up to 100% | Up to 100% | Up to 100% | Up to 100% |
| Observations/ | Observations/ | Observations/ | Observations/ | Observations/ |
| measurements | measurements | measurements | measurements | measurements |
| Appearance | Homogeneous | Homogeneous | Homogeneous | Homogeneous |
| | slightly yellow, | slightly yellow, | slightly yellow, | slightly yellow, |
| | viscous liquid | viscous liquid | viscous liquid | viscous liquid |
| Solubility/ | Foaming, | Foaming, | Foaming, | Foaming, |
| dispersibility in | homogeneous | homogeneous | homogeneous | homogeneous aqueous |
| water at 4 g/L | aqueous | aqueous mixture | aqueous mixture | mixture |
| deionized water | mixture | | | |

AEO: C13/C15 Oxo-alcohol (7EO) Lutensol ® AO7 (BASF SE) (CAS 68002-97-1)
AES: C12/C14-Fatty alcohol ethersulfate (2EO), sodium salt: Texapon ® N 70 (BASF SE) (CAS 68891-38-3)
LAS: Linear alkylbenzene sulfonic acid Maranil ® DBS/LC (BASF SE) (CAS 85536-14-7)
Coco fatty acid: Edenor ® K12-18 (Emery Oleochemicals) (CAS 90990-15-1) 1,2-propanediol: racemic mixture (CAS 57-55-6)
Tinosan ® HP 100 is a commercial product from BASF SE, containing 30% of the antimicrobial active 4,4′-dichloro-2-hydroxydiphenylether (CAS 3380-30-1) in 1,2-propyleneglycol.
2-phenoxyethanol (CAS 122-99-6) is available from BASF SE as Protectol ® PE
In the table above the concentrations of the surfactant trade products are given.

It is clear from the above table, that the present polymer P.1 and Tinosan HP 100 or 2-phenoxyethanol can be combined in a liquid laundry formulation.

1. A polypropylene imine polymer (PPI) comprising in polycondensed form at least one repeating unit selected from the following monomeric units:
(A)monomer (A) is represented by the following formula 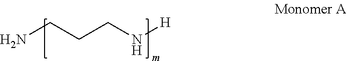
with m being selected from an integer of from 1 to 5,
(B)monomer (B) is represented by the following formula 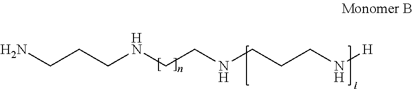
with n being selected from an integer of 1, 3, 4 and 5, and
with 1 being selected from 0 or 1,
and
(C)monomer (C) is represented by the following formula 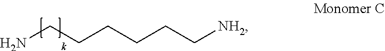
with k being selected from an integer of from 1 to 7, wherein
i) at least one repeating unit stemming from monomer A, and/or
ii) at least one repeating unit stemming from monomer B, and/or
iii) at least one repeating unit stemming from monomer C
is selected.

2. The PPI according to claim 1, having a weight-average molecular weight Mw of below 700 g/mol, and/or having a number-average molecular weight Mn from 200 to 400 g/mol and a weight-average molecular weight Mw from 300 to below 700 g/mol, and/or comprising on average at least 6 nitrogen atoms and at most 12 nitrogen atoms.

3. The PPI according to claim 1, that are essentially linear.

4. The PPI according to claim 1, having a melting point of at most 25° C.

5. The PPI according to claim 1, wherein the PPI is further modified by additionally comprising at least one side chain attached to at least one NH-functionality of the PPI, such chain consisting of moieties stemming from the polycondensation of at least one of the following further monomers
(D)at least one lactone and/or at least one hydroxy carbon acid, and
(E) at least one alkylene oxide (AO) being selected from the group consisting of C2 to C22-alkylene oxides,
wherein the order of D and E within the side chains can be any order such as random, block or statistical distribution, and
wherein the amount of D is from 0.5 to 15 based on mol equivalents per NH-functionality, and
wherein the amount of E is within 10 to 100 based on mol equivalents per NH-functionality.

6. The PPI according to claim 5, wherein the order of D and E in the side chains is in block order, and wherein the side chains are comprising at least one of the following structural orders
i) [PPI]—N-(E1)a-(D1)d-(E2)b-(E3)c
ii) [PPI]—N-(D1)d-(E2)b-(E3)c
iii) [PPI]—N-(E1)a-(D1)d-(E2)b
iv) [PPI]—N-(D1)d-(E2)b
v) [PPI]—N-(E1)a-(D1)d-(E2)b-(D2)e
vi) [PPI]—N-(D1)d-(E2)b-(D2)e
with (E1), (E2), (E3) each denoting sub-units each being independently from each other composed of monomers which is/are at least one alkylene oxide,
with (D1) and (D2) each denoting sub-units each being independently from each other composed of monomers which is/are at least one lactone(s) and/or hydroxy carbon acid(s),
with a, b, c, d and e defining the total average number of individual repeating units within each sub-unit (E1), (E2, (E3), (D1) and (D2),
and with the variables being based on average mol equivalents per NH-functionality of the PPI as follows:
a 0.5-2, and/or
b 10 to 40, and/or
c 5 to 40, and/or
d 0.5-5 and/or
e 2-10,
D1 is a linear or branched C3-C11 aliphatic lactone;
D2 is a linear or branched C3-C11 aliphatic lactone;
E1 is C2-C5-AO;
E2 is C2-C5-AO containing more than 50 wt % EO;
E3 is C2-C5-AO containing more than 50 wt % PO and/or BuO.

7. The PPI according to claim 6, wherein at least 50%, of all side chains attached to the NH-functionalities of one specific modified PPI have the same order within all side chains.

8. A process to produce the PPI according to claim 1 comprising the following steps
step a) of reacting at least one monomer (A) and/or at least one monomer (B) and/or at least one monomer (C), in a polycondensation reaction to obtain the PPI, wherein
monomer (A) is represented by the following formula 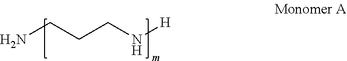
with m being selected from an integer of from 1 to 5,
monomer (B) is represented by the following formula 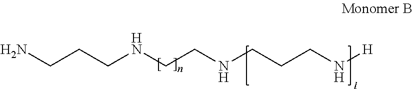
with n being selected from an integer of 1, 3, 4 and 5, and
with 1 being selected from 0 or 1,
and
monomer (C) is represented by the following formula 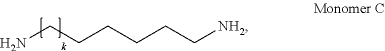
with k being selected from an integer of from 1 to 7,
to obtain a PPI having at least one of the following properties:
i) containing only at least one monomer selected from the group consisting of i) A, ii) B, iii) A and B, iv) A and C, v) B and C, vi) A and B and C;
ii) having a weight-average molecular weight Mw of below 700 g/mol;
iii) having a number-average molecular weight Mn from 200 to 400 g/mol and a weight-average molecular weight Mw from 300 to below 700 g/mol;
iv) having a poly dispersity index (PDI) of from 1.3 to 2.5;
v) comprising on average at least 6 nitrogen atoms and at most 12 nitrogen atoms;
vi) being predominantly linear and/or
vii) containing no tertiary amino group.

9. The process according to claim 8, wherein the process comprises a further step b), wherein the PPI obtained in step (a) is further modified in a further polycondensation reaction to produce a modified PPI comprising at least one side chain attached to at least one NH-functionality of the PPI, such chain consisting of moieties stemming from the polycondensation of at least one of the following further monomers
(D) at least one lactone and/or at least one hydroxy carbon acid, and/or
(E) at least one alkylene oxide being selected from the group consisting of C2 to C22-alkylene oxides,
by reacting the PPI with D and E by employing component(s) D and E as mixture, after-each other or with overlapping addition such that when the reaction with the first added reactant has proceeded to a conversion rate of at least 90% then the next reactant is added,
to obtain the order in i) to vi) to produce at least one side chain having a block structure selected from the following group i) to vi) with
i) [PPI]—N-(E1)a-(D1)e-(E2)b-(E3)c
ii) [PPI]—N-(D1)e-(E2)b-(E3)c
iii) [PPI]—N-(E1)a-(D1)e-(E2)b
iv) [PPI]—N(D1)e-(E2)b
v) [PPI]—N-(E1)a-(D1)e-(E2)b-(D2)f
vi) [PPI]—N-(D1)e-(E2)b-(D2)f
with (E1), (E2), (E3), each independently being a single or multiple alkylene oxide(s),
with (D1) and (D2) each independently being a single or multiple lactone(s) and/or hydroxy carbon acid(s),
with (E1)a, (E2)b, (E3)c, and (D1)e, (D2)f each denoting a block made from such starting material, wherein each block could be made up of more than one alkylene oxide or lactone(s) and/or hydroxy carbon acid(s), respectively, and thus within such block containing more than one alkylene oxide or lactone(s) and/or hydroxy carbon acid(s), the order is in random version,
the side chains structures selected from i), ii), iii) and iv),

10. A method of using at least one PPI according to
a) in cleaning compositions;
b) in fabric and home care products,
c) in formulations for electro plating;
d) in cementitious compositions;
e) in agrochemical formulations;
f) as adhesion promoters;
g) as an assistant (adhesion) with compatibilization not just of different polymer layers but also of metal foils;
h) as adhesion promoters for adhesives;
i) as a primer in coatings applications for improvement of adhesion on substrates;
j) for improvement of wet adhesion;
k) as complexing agents
l) as a flocculant in water treatment/water processing;
m) as a penetration aid;
n) as corrosion inhibitors;
o) for immobilization of proteins and enzymes, microorganisms or as immobilizing supports of enzymes and microorganisms;
p) for blocking and sealing;
q) as fixatives;
r) as an additive in the cosmetic formulations;
s) as an assistant in the papermaking industry;
t) for separation of oil and water;
u) as an additive for landfill seals;
v) as a flocculant;
w) as a swimming pool algicide;
x) for production of bitumen chemicals by reaction with fatty acids;
y) as an antiswelling agent in order that clay absorbs water in a retarded manner;
z) as an emulsifier or emulsion breaker;
aa) as a surfactant in the industrial cleaning (IC) sector;
bb) as a wood protector;
cc) for preparation of complexing agents (polycarboxylates);
dd) for production of assistants for ore mining and mineral processing;
ee) as a dispersant for pigments, ceramic, carbon black, carbon, carbon fibers, metal powders;
ff) for gas scrubbing as an absorbent of CO2, NOX, SOX, Cl2 and aldehydes, and for neutralization of acidic constituents;
gg) for water softening;
hh) as a crystallization inhibitor;
ii) as a rheology modifier (thickener);
jj) as an assistant or as a component for assistants for the extraction and processing of oil, coal and natural gas;
kk) for production of synthetic rubber and rubber chemicals;
ll) as an additive in coolants, lubricants and cooling lubricants;
mm) as assistants in the construction chemicals sector;
nn) as a constituent of galvanizing baths; or
oo) for production of nonviral gene vectors.

11. The method of using at least one PPI according to claim 10, the method comprising using at least one PPI in in liquid and solid detergent compositions, wherein such detergent compositions are
a) manual and automatic dish wash detergent compositions, comprising the at least one PPI, and the at least one chelating agent and/or the at least one surfactant or a surfactant system; and/or
b) laundry detergent compositions comprising the at least one PPI, and at least one surfactant or a surfactant system.

12. The method of using at least one PPI according to claim 10, the method comprising using at least one PPI for
i) improved removal of oily/fatty stains, and/or
ii) clay removal, and/or
iii) soil removal of particulate stains, and/or
iv) dispersion and/or emulsification of soils, and/or
v) modification of treated surface to improve removal upon later re-soiling, and/or
vi) prevention or reduction, preferably prevention, of glass corrosion, and/or
vii) whiteness improvement, and/or
viii) when at least one enzyme selected from the list consisting of lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of thereof, is present—additionally for improvement of removal of oily/fatty stains, food stain removal and/or removal of complex stains.

13. A composition that is a fabric and home care product, cleaning composition, industrial and institutional cleaning product, cosmetic or personal care product, oil field-formulation, crude oil emulsion breaker, pigment dispersion for inks, ink-jet inks, electro plating product, cementitious composition, lacquer, paint, or agrochemical formulation, each comprising at least one PPI according to claim 1.

14. A detergent composition comprising (i) at least one PPI according to claim 5, and (ii) at least one surfactant, wherein the composition is liquid, solid, or semi-solid, optionally further comprising (iii) water.

15. A detergent composition comprising (i) at least one PPI according to claim 1 and (ii) at least one chelating agent selected from the group consisting of methylglycine diacetic acid (MGDA), glutamic acid diacetate (GLDA), citric acid and salts thereof.

16. A composition according to claim 13 being a laundry detergent composition or a manual dish wash detergent composition,
optionally further comprising at least one enzyme, and
optionally containing at least one antimicrobial agent,
wherein the at least one PPI is present in an amount ranging from about 0.01% to about 20%, in relation to the total weight of such composition or product, and
such product or composition further comprising from about 1% to about 70% by weight of at least one surfactant.

17. A composition according to claim 13 being an automatic dish wash detergent composition comprising the at least one PPI in a total amount ranging from about 0.001% to about 10%,
further comprising at least one chelating agent in a total amount from about 1% to about 70%, and optionally further comprising at least one surfactant or a surfactant system in a total amount of from about 1% to about 70% by weight,
all weight percentages in relation to the total weight of such composition.

18. A composition according to claim 13 further comprising an antimicrobial agent selected from the group consisting of 2-phenoxyethanol and 4,4′-dichoro 2-hydroxydiphenylether.

19. A method of preserving an aqueous composition according to claim 13 against microbial contamination or growth, the method comprising adding an antimicrobial agent selected from the group consisting of 2-phenoxyethanol and 4,4′-dichoro 2-hydroxydiphenylether.
